(19) United States
(12) Patent Application Publication
(10) Pub. No.: US 2013/0181576 A1
(43) Pub. Date: Jul. 18, 2013

(54) HANDLER AND TEST APPARATUS

(71) Applicant: Seiko Epson Corporation, Tokyo (JP)

(72) Inventors: Masakuni SHIOZAWA, Chino (JP); Osamu MIYAZAWA, Shimosuwa (JP); Yoshiteru NISHIMURA, Shiojiri (JP)

(73) Assignee: SEIKO EPSON CORPORATION, Tokyo (JP)

(21) Appl. No.: 13/741,867

(22) Filed: Jan. 15, 2013

(30) Foreign Application Priority Data
Jan. 17, 2012 (JP) 2012-007468

(51) Int. Cl. H02N 2/00

(52) U.S. Cl. CPC H02N 2/0095
USPC 310/323.17

(57) ABSTRACT

A handler includes a supporting section, a holding section configured to hold an IC chip, and a position changing section between the supporting section and the holding section and configured to change the position of the IC chip held by the holding section. The position changing section includes a two-dimensional moving section that is movable in a predetermined direction, a pivoting section that is pivotable with respect to the two-dimensional moving section, and a piezoelectric actuator configured to move the two-dimensional moving section with respect to the supporting section.

### BACKGROUND

1. Technical Field

The present invention relates to a handler and a test apparatus.

2. Related Art

A test apparatus that tests electrical characteristics of an electronic component such as an IC chip is known (see JP-A-2010-91348).

The test apparatus disclosed in JP-A-2010-91348 supplies an electronic component from a supply tray to a test section, performs a test of the electrical characteristics of the electronic component supplied to the test section, and, after the test ends, collects the electronic component in a collection tray from a test socket. In the test apparatus disclosed in JP-A-2010-91348, the movement of the electronic component from the supply tray to the test section and the movement of the electronic component from the test section to the collection tray are performed by a test robot.

The test apparatus is roughly divided into a handler (sometimes referred to as IC test handler) and a test section (sometimes referred to as IC tester). The handler is a device that grips a component such as an IC and conveys the component to a predetermined position. The handler is a device including a Cartesian coordinate robot and a mechanism component such as a component gripping section.

Due to size reduction and high integration of electronic components in recent years, refining of a pitch of external terminals of the electronic component is in progress. Therefore, in order to accurately bring probe pins provided in the test section and the external terminals of the electronic component into contact with each other, highly accurate positioning in supplying the electronic component to the test section is required. Therefore, the test robot is configured to be capable of accurately positioning the electronic component with respect to the test section.

Specifically, the test section includes a sliding rail receiver and a pivoting correcting section pivotable about a Z axis with respect to the sliding rail receiver. The test section can highly accurately perform the positioning of the electronic component with respect to the test section by controlling the position of the sliding rail receiver with respect to a support body and the angle of the pivoting correcting section with respect to the sliding rail receiver.

However, in the test robot disclosed in JP-A-2010-91348, both the movement of the sliding rail receiver in an X axis direction and the movement of the sliding rail receiver in a Y axis direction with respect to the support body are performed using a motor. The pivoting of the pivoting correcting section with respect to the sliding rail receiver is also performed using the motor. The motor itself is relatively large. Moreover, components such as a rack gear and a pinion gear are separately necessary in order to change the direction of a driving axis (a pivot axis). Therefore, in the test apparatus disclosed in JP-A-2010-91348, an increase in the size of the test robot, and in particular, an increase in the size of a portion for holding the electronic component is caused.

When the test robot is increased in size, the number of electronic components that can be arranged in a unit region decreases. Therefore, the number of electronic components that can be tested in one test process including the supply of an electronic component to the test section and the collection of the electronic component in the collection tray also decreases.

### SUMMARY

An advantage of some aspects of the invention is to provide a handler that can be reduced in size and a test apparatus including the handler.

The invention can be implemented in the following forms or application examples.

### Application Example 1

This application example of the invention is directed to a handler including: a base section; a holding section configured to hold a member; and a position changing mechanism section, at least apart of which is provided between the base section and the holding section, the position changing mechanism section changing the position of the member held by the holding section with respect to the base section. The position changing mechanism section includes a two-dimensional moving section that is movable in a predetermined direction, a pivoting section that is pivotable with respect to the two-dimensional moving section, and a piezoelectric actuator configured to move the two-dimensional moving section with respect to the base section.

Consequently, it is possible to provide a small handler. Specifically, when the piezoelectric actuator is used as a driving source that moves the two-dimensional moving section, since the piezoelectric actuator is thin (small) compare with a motor, which is a driving source in the past, and directly drives the pivoting section without another member, it is possible to realize a reduction in the size of an apparatus compared with the configuration in the past. Further, when the piezoelectric actuator is used, since a degree of freedom of the arrangement thereof increases, a degree of freedom of design of the handler increases and it is possible to realize a reduction in the size of the handler.

### Application Example 2

In the handler, it is preferable that the two-dimensional moving section includes a first moving section that is movable in a first direction with respect to the base section and a second moving section that is movable in a second direction crossing the first direction.

Consequently, since the positioning of the member can be two-dimensionally corrected, positioning accuracy of the member is further improved.

### Application Example 3

In the handler, it is preferable that the position changing mechanism section includes a first piezoelectric actuator configured to move the first moving section with respect to the base section and a second piezoelectric actuator configured to move the second moving section with respect to the first moving section.

Consequently, it is possible to move the first moving section and the second moving section using a small driving source. It is possible to realize a reduction in the size of the handler.

### Application Example 4

In the handler, it is preferable that the first piezoelectric actuator and the second piezoelectric actuator are provided along a side surface of the two-dimensional moving section.

Consequently, it is possible to suppress excess projection of the first and second piezoelectric actuators to the outside. It is possible to realize a further reduction in the size of the handler.

### Application Example 5

In the handler, it is preferable that the first piezoelectric actuator is fixed to the first moving section.

The first moving section is a first moving section of a so-called “self-propelled type” in which the first piezoelectric actuator is provided in the first moving section and the first moving section is moved in the first direction with respect to the supporting section by the driving of the first piezoelectric actuator. Therefore, a degree of freedom of the arrangement of the first piezoelectric actuator increases. It is possible to realize a further reduction in the size of the handler.

### Application Example 6

In the handler, it is preferable that the second piezoelectric actuator is fixed to the second moving section.

The second moving section is a second moving section of so-called “self-propelled type” in which the second piezoelectric actuator is provided in the second moving section and the second moving section is moved in the second direction with respect to the supporting section by the driving of the second piezoelectric actuator. Therefore, a degree of freedom of the arrangement of the second piezoelectric actuator increases. It is possible to realize a further reduction in the size of the handler.

### Application Example 7

In the handler, it is preferable that the position changing mechanism section further includes a piezoelectric actuator for the pivoting section fixed to the two-dimensional moving section and configured to cause the pivoting section to pivot with respect to the two-dimensional moving section.

Consequently, it is possible to cause the pivoting section to pivot using a small driving source and realize a reduction in the size of the handler.

### Application Example 8

In the handler, it is preferable that the piezoelectric actuator for the pivoting section is provided in a position spaced apart from a pivot axis of the pivoting section.

Consequently, a degree of freedom of design of the handler increases. Specifically, for example, even when a through-hole extending along the pivot axis is formed in the pivoting section and another member is inserted into the through-hole, it is possible to prevent the piezoelectric actuator for the pivoting section from obstructing the arrangement of the other member.

### Application Example 9

In the handler, it is preferable that the piezoelectric actuator for the pivoting section is provided along a side surface of the two-dimensional moving section.

Consequently, it is possible to suppress excess projection of the piezoelectric actuator for the pivoting section to the outside and realize a further reduction in the size of the handler.

### Application Example 10

In the handler, it is preferable that the pivoting section includes a through-hole that pierces through the pivoting section in a pivot axis direction.

Consequently, it is possible to insert another member through the through-hole or arrange the other member in the through-hole. Therefore, a degree of freedom of design of the handler increases.

### Application Example 11

In the handler, it is preferable that the handler includes an axis direction moving section inserted through the through-hole of the pivoting section and movable in the pivot axis direction with respect to the pivoting section.

Consequently, for example, when the member held by the holding section is pressed against another member, the axis direction moving section can receive a pressing force of the member by moving in the pivot axis direction. In other words, the axis direction moving section can function as a stress absorbing section and suppress excess stress from being applied to the handler and the member.

### Application Example 12

In the handler, it is preferable that the axis direction moving section is regulated from pivoting with respect to the pivoting section.

Consequently, it is possible to prevent undesired pivoting of the member held by the holding section with respect to the supporting section.

### Application Example 13

In the handler, it is preferable that the first piezoelectric actuator, the second piezoelectric actuator, and the piezoelectric actuator for the pivoting section are formed in a tabular shape.

Consequently, it is possible to realize a further reduction in the size of the handler.

### Application Example 14

This application example of the invention is directed to a test apparatus including: the handler according to the aspect; and a test section configured to perform a test of a member. The member is conveyed to the test section by the handler.

Consequently, it is possible to provide a test apparatus having an excellent test characteristic.

### BRIEF DESCRIPTION OF THE DRAWINGS

The invention will be described with reference to the accompanying drawings, wherein like numbers reference like elements.

FIG. 1 is a schematic plan view showing a test apparatus according to a first embodiment of the invention.

FIG. 2 is a sectional view showing an individual test socket included in the test apparatus shown in FIG. 1.

FIG. 3 is a partial sectional view showing a hand unit of a supply robot included in the test apparatus shown in FIG. 1.

FIG. 4 is a partial sectional view showing a hand unit of a test robot included in the test apparatus shown in FIG. 1.

FIG. 5 is a partial sectional view showing the hand unit of the test robot included in the test apparatus shown in FIG. 1.

FIG. 6 is a plan view showing the hand unit of the test robot included in the test apparatus shown in FIG. 1.

FIG. 7 is a partial sectional view showing the hand unit of the test robot included in the test apparatus shown in FIG. 1.

FIG. 8 is a perspective view showing a piezoelectric actuator included in the hand unit shown in FIG. 5.

FIG. 9 is a plan view for explaining a driving principle of the piezoelectric actuator shown in FIG. 8.

FIG. 10 is a plan view for explaining the driving principle of the piezoelectric actuator shown in FIG. 8.

FIG. 11 is a plan view for explaining a test procedure for an electronic component by the test apparatus shown in FIG. 1.

FIG. 12 is a plan view for explaining the test procedure for the electronic component by the test apparatus shown in FIG. 1.

FIG. 13 is a plan view for explaining the test procedure for the electronic component by the test apparatus shown in FIG. 1.

FIG. 14 is a plan view for explaining the test procedure for the electronic component by the test apparatus shown in FIG. 1.

FIG. 15 is a plan view for explaining the test procedure for the electronic component by the test apparatus shown in FIG. 1.

FIG. 16 is a plan view for explaining the test procedure for the electronic component by the test apparatus shown in FIG. 1.

FIG. 17 is a plan view for explaining the test procedure for the electronic component by the test apparatus shown in FIG. 1.

FIG. 18 is a plan view for explaining the test procedure for the electronic component by the test apparatus shown in FIG. 1.

FIG. 19 is a plan view for explaining the test procedure for the electronic component by the test apparatus shown in FIG. 1.

FIG. 20 is a side view showing a hand unit included in a test apparatus according to a second embodiment of the invention.

### DESCRIPTION OF EXEMPLARY EMBODIMENTS

A test apparatus to which a handler according to the invention is applied (a test apparatus according to the invention) is explained in detail below based on embodiments shown in the accompanying drawings.

### First Embodiment

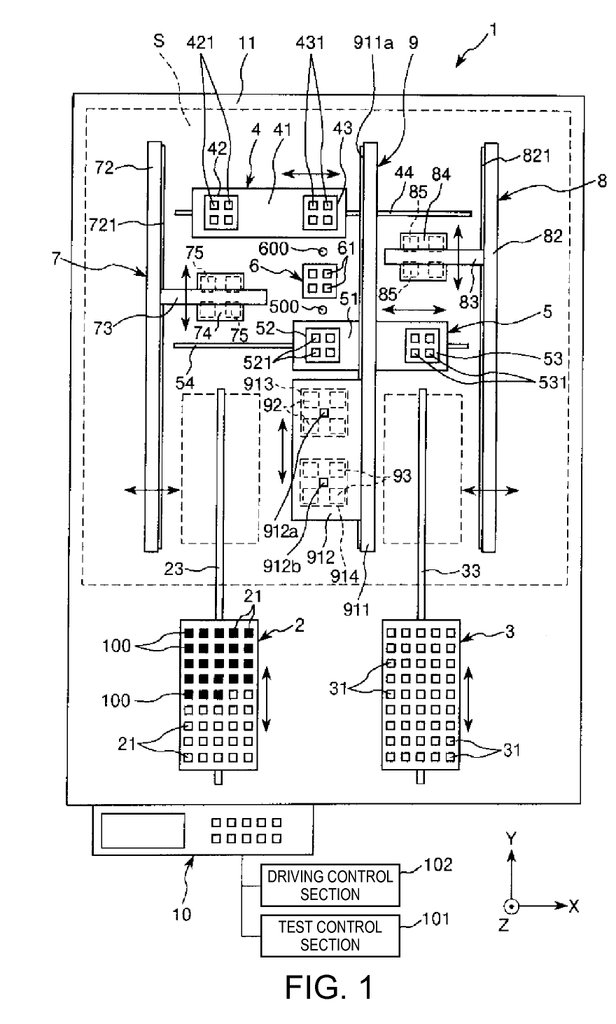

FIG. 1 is a schematic plan view showing a test apparatus according to a first embodiment of the invention.

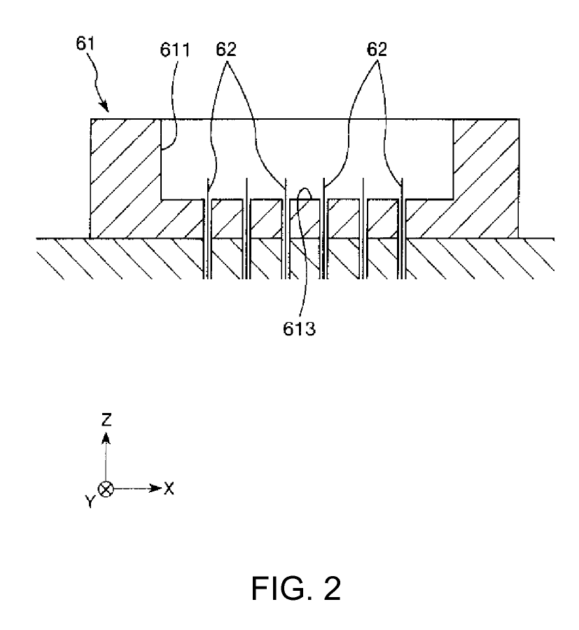

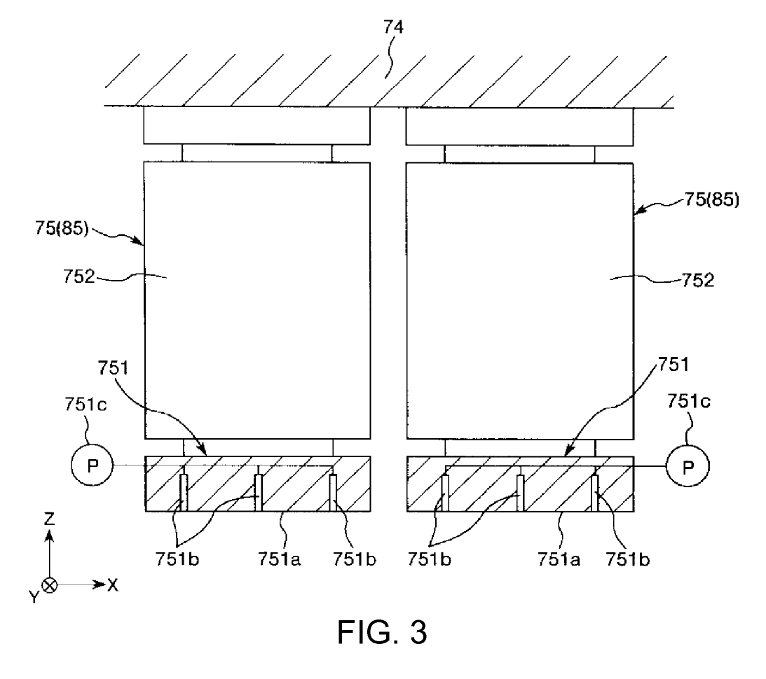

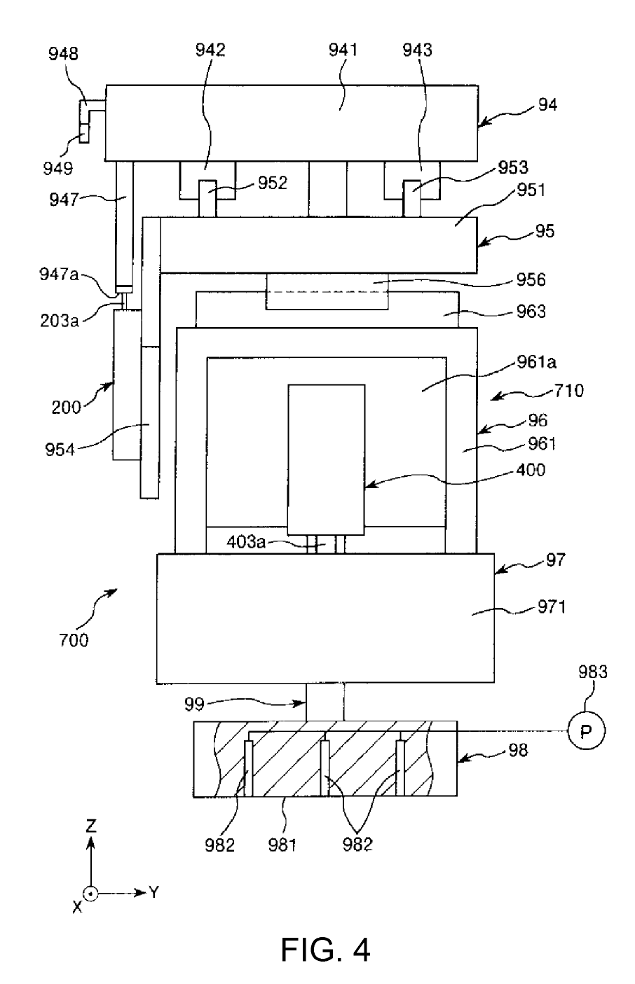

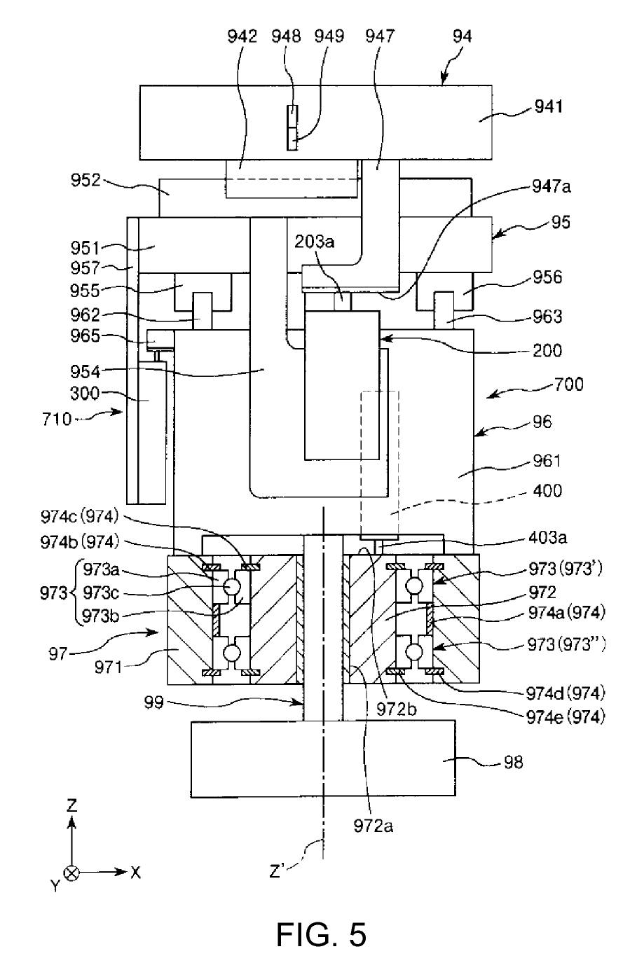

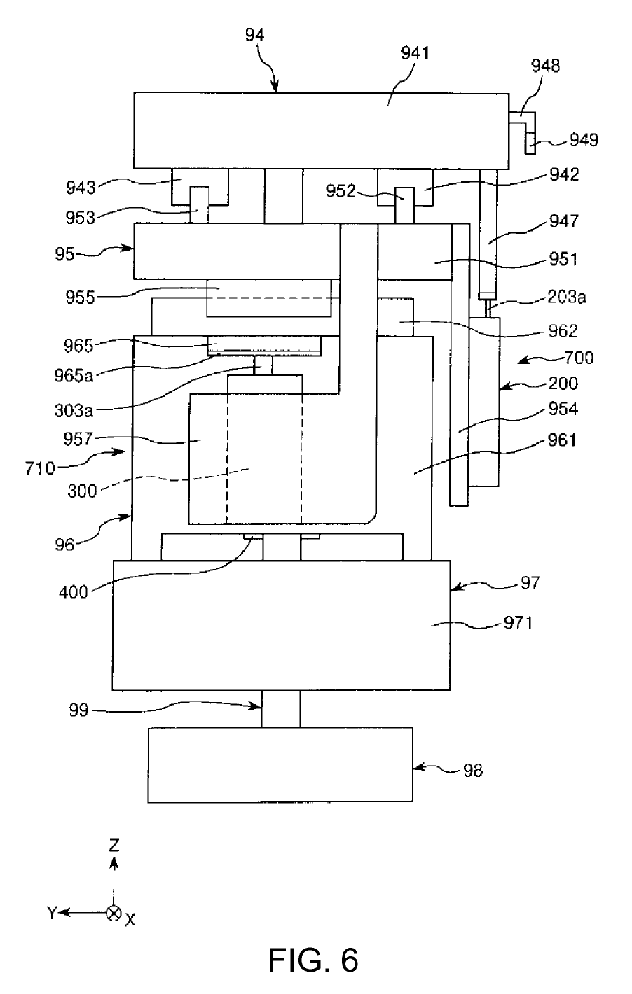

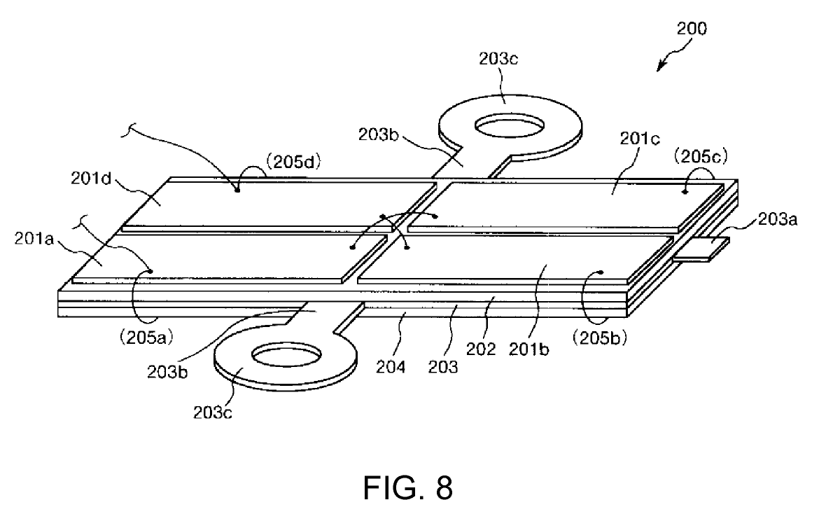

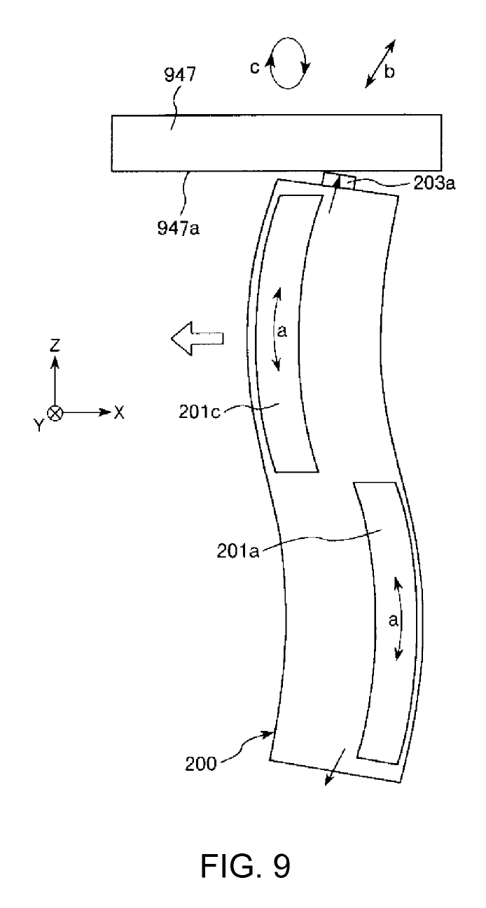

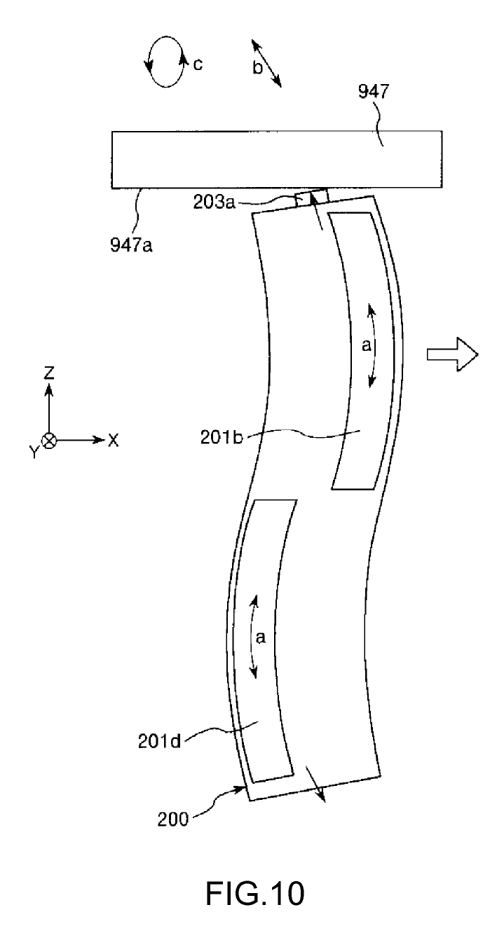

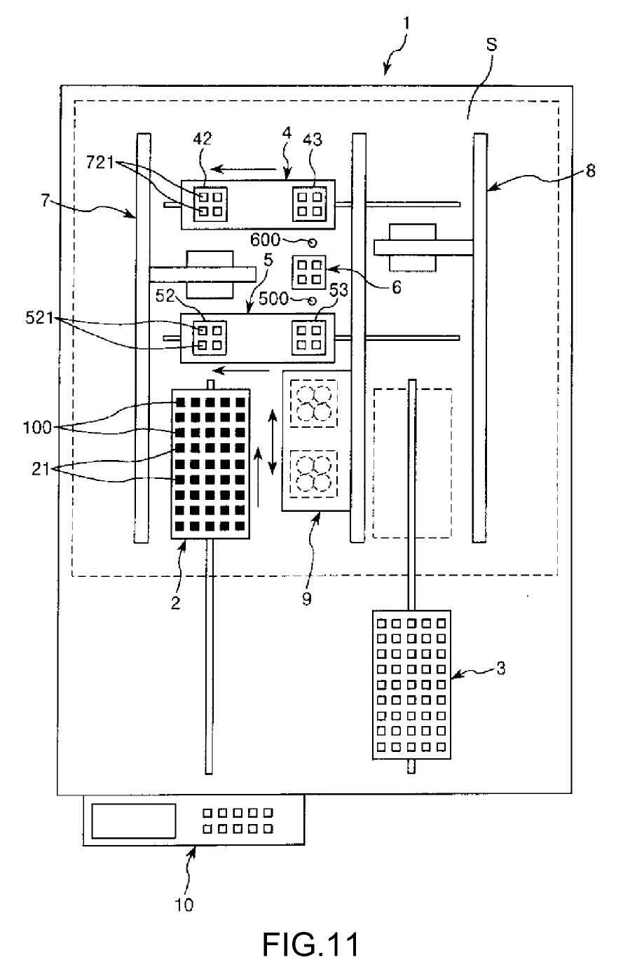

FIG. 2 is a sectional view showing an individual test socket included in the test apparatus shown in FIG. 1. FIG. 3 is a partial sectional view showing a hand unit of a supply robot included in the test apparatus shown in FIG. 1. FIGS. 4 to 7 are partial sectional views (FIGS. 4, 5, and 7) and a plan view (FIG. 6) showing the hand unit of the test robot included in the test apparatus shown in FIG. 1. FIG. 8 is a perspective view showing a piezoelectric actuator included in the hand unit shown in FIG. 5. FIGS. 9 and 10 are plan views for explaining a driving principle of the piezoelectric actuator shown in FIG. 8. FIGS. 11 to 19 are plan views for explaining a test procedure for an electronic component by the test apparatus shown in FIG. 1.

In the following explanation, as shown in FIG. 1, three axes that are orthogonal to one another are set as an X axis, a Y axis, and a Z axis. A direction parallel to the X axis is referred to as “X direction (first direction)”. A direction parallel to the Y axis is referred to as “Y direction (second direction)”. A direction parallel to the Z axis is referred to as “Z direction (third direction)”. In the X direction, the Y direction, and the Z direction, an arrow distal end side is referred to as (+) side and an arrow proximal end side is referred to as (−) side.

### Test Apparatus

A test apparatus 1 shown in FIG. 1 is an apparatus for testing the electrical characteristics of IC chips (electronic components) 100, which are “members”. The IC chips 100 to be tested are not specifically limited. However, examples of the IC chips 100 include IC chips such as a ball device having a narrowly spaced external terminals and a WLCSP susceptible to a shock. With the test apparatus 1, it is possible to perform highly accurate positioning of the IC chips 100. Therefore, the test apparatus 1 is suitable for testing a chip having external terminals arranged at a narrow pitch and a chip that is easily damaged.

The test apparatus 1 includes a supply tray 2, a collection tray 3, a first shuttle 4, a second shuttle 5, a test socket (a test section) 6, a supply robot 7, a collection robot 8, a test robot 9, a control device 10 configured to perform control of the sections, a first camera 600, and a second camera 500.

In the test apparatus 1 according to this embodiment, a handler that executes conveyance of the IC chips 100 (a handler according to the embodiment of the invention) is configured by the components excluding the test socket 6 among the sections, i.e., by the supply tray 2, the collection tray 3, the first shuttle 4, the second shuttle 5, the supply robot 7, the collection robot 8, the test robot 9, the control device 10, the first camera 600, and the second camera 500.

The test apparatus 1 includes a pedestal 11 on which the sections are placed and a safety cover (not-shown) configured to cover the pedestal 11 to house the sections. The first shuttle 4, the second shuttle 5, the test socket 6, the supply robot 7, the collection robot 8, the test robot 9, the first camera 600, and the second camera 500 are arranged on the inner side of the safety cover (hereinafter referred to as “region S”). The supply tray 2 and the collection tray 3 are arranged to be movable to the inside and the outside of the region S. A test of the electrical characteristics of the IC chips 100 is performed on the inside of the region S.

### Supply Tray

The supply tray 2 is a tray for conveying the IC chips 100 to be tested from the outside to the inside of the region S. As shown in FIG. 1, the supply tray 2 is formed in a tabular shape. A plurality of (a large number of) pockets 21 for holding the IC chips 100 are formed in a matrix shape on the upper surface of the supply tray 2.

The supply tray 2 is supported by a rail 23 extending in the Y direction across the inside and the outside of the region S. The supply tray 2 can be reciprocatingly moved in the Y direction along the rail 23 by a driving mechanism (not-shown) such as a linear motor. Therefore, after the IC chips 100 are arranged on the supply tray 2 outside the region S, the supply tray 2 can be moved to the inside of the region S. After all the IC chips 100 are removed from the supply tray 2, the supply tray 2 on the inside of the region S can be moved to the outside of the region S.

The supply tray 2 does not have to be directly supported by the rail 23. For example, a configuration may be adopted in which a stage including a placing surface is supported by the rail 23 and the supply tray 2 is placed on the placing surface of the stage. With such a configuration, it is possible to store the IC chips 100 on the supply tray 2 in a place separate from the test apparatus 1. Therefore, the convenience of the apparatus is improved. The same configuration can be adopted for the collection tray 3 explained below.

### Collection Tray

The collection tray 3 is a tray for storing the tested IC chips 100 and conveying the IC chips 100 from the inside to the outside of the region S. As shown in FIG. 1, the collection tray 3 is formed in a tabular shape. A plurality of pockets 31 for holding the IC chips 100 are formed in a matrix shape on the upper surface of the collection tray 3.

The collection tray 3 is supported by a rail 33 extending in the Y direction across the inside and the outside of the region S. The collection tray 3 can be reciprocatingly moved in the Y direction along the rail 33 by a driving mechanism (not-shown) such as a linear motor. Therefore, after the tested IC chips 100 are arranged on the collection tray 3 on the outside of the region S, the collection tray 3 can be moved to the inside of the region S. After all the IC chips 100 are removed from the collection tray 3, the collection tray 3 can be moved to the outside of the region S.

Like the supply tray 2, the collection tray 3 does not have to be directly supported by the rail 33. For example, a configuration may be adopted in which a stage including a placing surface is supported by the rail 33 and the collection tray 3 is placed on the placing surface of the stage.

The collection tray 3 is spaced apart from the supply tray 2 in the X direction. The first shuttle 4, the second shuttle 5, and the test socket 6 are arranged between the supply tray 2 and the collection tray 3.

### First Shuttle

The first shuttle 4 is a shuttle for further conveying the IC chips 100, which are conveyed to the inside of the region S by the supply tray 2, to the vicinity of the test socket 6 and conveying the tested IC chips 100, which are tested by the test socket 6, to the vicinity of the collection tray 3.

As shown in FIG. 1, the first shuttle 4 includes a base member 41 and two trays 42 and 43 fixed to the base member 41. The two trays 42 and 43 are provided side by side in the X direction. Four pockets 421 and four pockets 431 for holding the IC chips 100 are respectively formed on the upper surfaces of the trays 42 and 43 in a matrix shape. Specifically, the four pockets 421 and the four pockets 431 are formed on the trays 42 and 43 such that a pair of the pockets are arranged in each of the X direction and the Y direction.

The tray 42 located on the supply tray 2 side is a tray for storing the IC chips 100 stored in the supply tray 2. The tray 43 located on the collection tray 3 side is a tray for storing the IC chips 100, a test of the electrical characteristics of which in the test socket 6 ends. In other words, one tray 42 is a tray for storing the IC chips 100 not tested yet and the other tray 43 is a tray for storing the tested IC chips 100.

The IC chips 100 stored in the tray 42 are conveyed to the test socket 6 by the test robot 9. The IC chips 100 arranged on the test socket 6 to be tested are conveyed to the tray 43 by the test robot 9 after the test ends.

The first shuttle 4 is supported by a rail 44 extending in the X direction. The first shuttle 4 can be reciprocatingly moved in the X direction along the rail 44 by a driving mechanism (not shown) such as a linear motor. Consequently, the first shuttle 4 can take a state in which the first shuttle 4 moves in the X direction (−) side, the tray 42 is arranged on the Y direction (+) side with respect to the supply tray 2, and the tray 43 is arranged on the Y direction (+) side with respect to the test socket 6 and a state in which the tray 43 is arranged on the Y direction (+) side with respect to the collection tray 3 and the tray 42 is arranged on the Y direction (+) side with respect to the test socket 6.

### Second Shuttle

The second shuttle 5 has a function and a configuration that are the same as those of the first shuttle 4 explained above. Specifically, the second shuttle 5 is a shuttle for further conveying the IC chips 100, which are conveyed to the inside of the region S by the supply tray 2, to the vicinity of the test socket 6 and conveying the tested IC chips 100 tested by the test socket 6 to the vicinity of the collection tray 3.

As shown in FIG. 1, the second shuttle 5 includes a base member 51 and two trays 52 and 53 fixed to the base member 51. The two trays 52 and 53 are provided side by side in the X direction. Four pockets 521 and four pockets 531 for holding the IC chips 100 are respectively formed on the upper surfaces of the trays 52 and 53 in a matrix shape.

The tray 52 located on the supply tray 2 side is a tray for storing the IC chips 100 stored in the supply tray 2. The tray 53 located on the collection tray 3 side is a tray for storing the IC chips 100, after a test of the electrical characteristics of which in the test socket 6 ends.

The IC chips 100 stored in the tray 52 are conveyed to the test socket 6 by the test robot 9. The IC chips 100 arranged on the test socket 6 to be tested are conveyed to the tray 53 by the test robot 9 after the test ends.

The second shuttle 5 is supported by a rail 54 extending in the X direction. The second shuttle 5 can be reciprocatingly moved in the X direction along the rail 54 by a driving mechanism (not shown) such as a linear motor. Consequently, the second shuttle 5 can take a state in which the second shuttle 5 moves in the X direction (−) side, the tray 52 is arranged on the Y direction (+) side with respect to the supply tray 2, and the tray 53 is arranged on the Y direction (−) side with respect to the test socket 6 and a state in which the second shuttle 5 moves in the X direction (+) side, the tray 53 is arranged on the Y direction (+) side with respect to the collection tray 3, and the tray 52 is arranged on the Y direction (−) side with respect to the test socket 6.

The second shuttle 5 is provided to be spaced apart from the first shuttle 4 in the Y direction. The test socket 6 is arranged between the first shuttle 4 and the second shuttle 5.

### Test Socket

The test socket (the test section) 6 is a socket for testing the electrical characteristics of the IC chips 100.

The test socket 6 includes four individual test sockets 61 for arranging the IC chips 100. The four individual test sockets 61 are provided in a matrix shape. Specifically, the four individual test sockets 61 are provided to be arranged such that a pair of the individual sockets are arranged in each of the X direction and the Y direction. The number of the individual test sockets 61 is not limited to four and may be one to three or may be five or more. An array state of the individual test sockets 61 is not specifically limited. For example, the individual test sockets 61 may be arranged in a row in the X direction or the Y direction.

From the viewpoint of efficiency of work, a larger number of the individual test sockets 61 is better. However, when a reduction in the size of the test apparatus 1 is further taken into account, the number of the individual test sockets 61 is desirably about four to twenty. Consequently, the number of the IC chips 100 that can be tested in one test is sufficiently large. Therefore, it is possible to realize efficiency of work. A plurality of the individual test sockets 61 may be arrayed in a matrix shape or may be arrayed in one row. In other words, the individual test sockets 61 may be arranged in a matrix shape such as 2×2, 4×4, or 8×2 or may be arranged in a row such as 4×1 or 8×1.

The array of the pockets 421 formed on the tray 42 (the same applies to the trays 43, 52, and 53) is desirably the same as the array of the individual test sockets 61. A disposing pitch of the pockets 421 is desirably substantially equal to that of the individual test sockets 61. Consequently, it is possible to smoothly transfer the IC chips 100 stored in the trays 42 and 52 to the individual test sockets 61. It is possible to smoothly transfer the IC chips 100 arranged on the individual test sockets 61 to the trays 43 and 53. Therefore, it is possible to realize efficiency of work.

As shown in FIG. 2, each of the individual test sockets 61 includes a side surface 611 perpendicular to the XY plane. A side surface of the individual test socket in the past is formed in a taper shape to make it easy to arrange the IC chip 100 in the individual test socket. The side surface is formed in the taper shape in this way because positioning of the IC chip 100 with respect to the individual test socket cannot be highly accurately performed. On the other hand, in the embodiment of the invention, positioning of the IC chip 100 with respect to the individual test socket 61 can be more highly accurately performed than the apparatus in the past. Therefore, it is unnecessary to form the side surface in the taper shape. The side surface is formed of a surface perpendicular to the XY plane, whereby it is possible to more surely hold the IC chip 100 in the individual test socket 61 compared with the individual test socket in the past having the side surface formed in the taper shape. In other words, it is possible to more surely prevent undesired displacement of the IC chip 100 in the individual test socket 61.

In each of the individual test sockets 61, a plurality of probe pins 62 projecting from a bottom section 613 are provided. The plurality of probe pins 62 are respectively urged upward by springs (not-shown). When the IC chip 100 is arranged in the individual test socket 61, the probe pins 62 come into contact with external terminals of the IC chip 100. Consequently, the individual test socket 61 is in a state in which the IC chip 100 and the test control section 101 are electrically connected via the probe pins 62, i.e., a state in which a test of the electrical characteristics of the IC chip 100 can be performed.

A camera (not-shown) is provided in the vicinity of the test socket 6. A socket mark (not-shown) is provided in the vicinity of the individual test socket 61. Consequently, it is possible to recognize the position of the individual test socket 61 and a relative position of the socket mark, recognize relative positions of the socket mark and a device mark 949, recognize relative positions of the device mark 949 and the IC chip 100, and accurately position the individual test socket 61 and the IC chip 100 using the camera.

### First Camera

As shown in FIG. 1, the first camera 600 is provided between the first shuttle 4 and the test socket 6 and on the Y direction (+) side with respect to the test socket 6. As explained below, when a first hand unit 92 of the test robot 9 that holds the IC chips 100 stored in the tray 42 passes above the first camera 600, the first camera 600 picks up an image of the IC chips 100 held by the first hand unit 92 and the device mark 949 included in the first hand unit 92.

### Second Camera

As shown in FIG. 1, the second camera 500 has a function that is the same as the function of the first camera 600 explained above. The second camera 500 is provided between the second shuttle 5 and the test socket 6 and on the Y direction (−) side with respect to the test socket 6. As explained below, when a second hand unit 93 of the test robot 9 that holds the IC chips 100 stored in the tray 52 passes above the second camera 500, the second camera 500 picks up images of the IC chips 100 held by the second hand unit 93 and a device mark of the second hand unit 93.

### Supply Robot

The supply robot 7 is a robot for transferring the IC chips 100 stored in the supply tray 2, which is conveyed to the inside of the region 5, to the tray 42 of the first shuttle 4 and the tray 52 of the second shuttle 5.

As shown in FIGS. 1 and 3, the supply robot 7 includes a supporting frame 72 supported by the pedestal 11, a moving frame (a Y-direction moving frame) 73 supported by the supporting frame 72 and capable of reciprocatingly moving in the Y direction with respect to the supporting frame 72, a hand-unit supporting section (an X-direction moving frame) 74 supported by the moving frame 73 and capable of reciprocatingly moving in the X axis direction with respect to the moving frame 73, and four hand units 75 supported by the hand-unit supporting section 74.

A rail 721 extending in the Y direction is formed in the supporting frame 72. The moving frame 73 reciprocatingly moves in the Y direction along the rail 721. A rail (not-shown) extending in the X direction is formed in the moving frame 73. The hand-unit supporting section 74 reciprocatingly moves in the X direction along the rail.

Each of the movement of the moving frame 73 with respect to the supporting frame 72 and the movement of the hand-unit supporting section 74 with respect to the moving frame 73 can be performed by a moving mechanism (not shown) such as a linear motor.

The four hand units 75 are arranged in a matrix shape such that a pair of the hand units are arranged in each of the X direction and the Y direction. In this way, the hand units 75 are provided to correspond to the arrays of the four pockets 421 and the four pockets 521 formed in the trays 42 and 52. Consequently, it is possible to smoothly transfer the IC chips 100 from the supply tray 2 to the trays 42 and 52. The number of the hand units 75 is not limited to four and, for example, may be one to three or may be five or more. The hand units 75 may be structured such that the array of the hand units 75 can be changed according to the array of the pockets 21 and the arrays of the pockets 421 and 521.

As shown in FIG. 3, each of the hand units 75 includes a holding section 751 located on the distal end side and configured to hold the IC chip 100 and a lifting and lowering device 752 configured to reciprocatingly move (lift and lower) the holding section 751 in the Z direction with respect to the hand-unit supporting section 74. The lifting and lowering device 752 can be a device that makes use of a driving mechanism such as a linear motor.

The holding section 751 includes an attracting surface 751a opposed to the IC chip 100, an attracting hole 751b opened to the attracting surface 751a, and a decompressing pump 751c configured to decompress the inside of the attracting hole 751b. In a state in which the attracting surface 751a is set in contact with the IC chip 100 to close the attracting hole 751b, when the inside of the attracting hole 751b is decompressed by the decompressing pump 751c, the IC chip 100 can be attracted to and held on the attracting surface 751a. Conversely, when the decompressing pump 751c is stopped and the inside of the attracting hole 751b is opened, the held IC chip 100 can be released.

The supply robot 7 conveys the IC chips 100 from the supply tray 2 to the trays 42 and 52 as explained below. The IC chips 100 are conveyed from the supply tray 2 to the tray 42 and to the tray 52 by the same method. Therefore, the conveyance of the IC chip 100 to the tray 42 is representatively explained below.

First, the first shuttle 4 is moved to the X direction (−) side to arrange the tray 42 in the Y direction with respect to the supply tray 2. Subsequently, the moving frame 73 is moved in the Y direction and the hand-unit supporting section 74 is moved in the X direction to locate the hand units 75 on the supply tray 2. The holding sections 751 are lowered by the lifting and lowering devices 752 and brought into contact with the IC chips 100 on the supply tray 2. The holding sections 751 are caused to hold the IC chips 100 by the method explained above.

Subsequently, the holding sections 751 are lifted by the lifting and lowering devices 752 to remove the held IC chips 100 from the supply tray 2. The moving frame 73 is moved in the Y direction and the hand-unit supporting section 74 is moved in the X direction to locate the hand units 75 on the tray 42 of the first shuttle 4. The holding sections 751 are lowered by the lifting and lowering devices 752. The IC chips 100 held by the holding sections 751 are arranged in the pockets 421 of the tray 42. The attracted state of the IC chip 100 is released to release the IC chips 100 from the holding sections 751. Such work may be repeated as desired.

Consequently, the conveyance (the transfer) of the IC chips 100 from the supply tray 2 to the tray 42 is completed.

### Test Robot

The test robot 9 is a device that further conveys the IC chips 100, which are conveyed to the trays 42 and 52 by the supply robot 7, to the test socket 6 and conveys the IC chips 100, a test of the electrical characteristics of which ends, arranged on the test socket 6 to the trays 43 and 53.

When the IC chips 100 are conveyed from the trays 42 and 52 to the test socket 6, the test robot 9 can highly accurately perform positioning of the IC chip 100 with respect to the test socket 6 (the individual test sockets 61).

The test robot 9 also as a function of, when the IC chips 100 are arranged on the test socket 6 and a test of the electrical characteristics is performed, pressing the IC chips 100 against the probe pins 62 and applying predetermined test pressure to the IC chips 100.

As shown in FIG. 1, the test robot 9 includes a first frame 911 fixedly provided on the pedestal 11, a second frame 912 supported by the first frame 911 and capable of reciprocatingly moving in the Y direction with respect to the first frame 911, a first hand-unit supporting section 913 and a second hand-unit supporting section 914 supported by the second frame 912 and capable of reciprocatingly moving (ascending and descending) in the Z direction with respect to the second frame 912, four first hand units 92 supported by the first hand-unit supporting section 913, and four second hand units 93 supported by the second hand-unit supporting section 914.

A rail 911a extending in the Y direction is formed in the first frame 911. The second frame 912 reciprocatingly moves in the Y direction along the rail 911a. Through-holes 912a and 912b extending in the Z direction are formed in the second frame 912. The first hand-unit supporting section 913 reciprocatingly moves in the Z direction along the through-hole 912a. The second hand-unit supporting section 914 reciprocatingly moves in the Z direction along the through-hole 912b.

Both the first and second hand-unit supporting sections 913 and 914 are supported by the second frame 912. Therefore, the first and second hand-unit supporting sections 913 and 914 integrally move in the X direction and the Y direction. However, the first and second hand-unit supporting sections 913 and 914 can move independently from each other in the Z direction. The movement of the second frame 912 with respect to the first frame 911 and the movement of the hand-unit supporting sections 913 and 914 with respect to the second frame 912 can be performed by a driving mechanism (not shown) such as a linear motor.

The four first hand units 92 supported by the first hand-unit supporting section 913 are devices that convey the IC chips 100 between the trays 42 and 43 of the first shuttle 4 and the test socket 6. The four first hand units 92 are also devices that perform positioning of the IC chips 100 with respect to the test socket 6 (the individual test sockets 61) when the IC chips 100 not tested yet are conveyed from the tray 42 to the test socket 6.

Similarly, the four second hand units 93 supported by the second hand-unit supporting section 914 are devices that convey the IC chips 100 between the trays 52 and 53 of the second shuttle 5 and the test socket 6. The four second hand units 93 are also devices that perform positioning of the IC chips 100 with respect to the test socket 6 (the individual test sockets 61) when the IC chips 100 not inspected yet are conveyed from the tray 52 to the test socket 6.

The four first hand units 92 are arranged in a matrix shape on the lower side of the first hand-unit supporting section 913 such that a pair of the first hand units are arranged in each of the X direction and the Y direction. A disposing pitch of the four first hand units 92 is substantially equal to the disposing pitch of the four pockets 421 formed in the tray 42 (the same applies to the trays 43, 52, and 53) and the four individual test sockets 61 provided in the test socket 6.

As explained above, the first hand units 92 are arranged to correspond to the arrays of the pockets 421 and the individual test sockets 61. Consequently, it is possible to smoothly convey the IC chips 100 between the trays 42 and 43 and the test socket 6.

The number of the first hand units 92 is not limited to four and, for example, may be one to three or may be five or more.

Similarly, the four second hand units 93 are arranged in a matrix shape on the lower side of the second hand-unit supporting section 914 such that a pair of the second hand units are arranged in each of the X direction and the Y direction. The arrangement and a disposing pitch of the four second hand units 93 are the same as those of the four first hand units 92 explained above.

The configuration of the first hand units 92 and the second hand units 93 is explained in detailed below with reference to FIGS. 4 to 9. The hand units 92 and 93 have the same configuration. Therefore, one first hand unit 92 is representatively explained below. The explanation of the other first hand units 92 and the second hand units 93 is omitted.

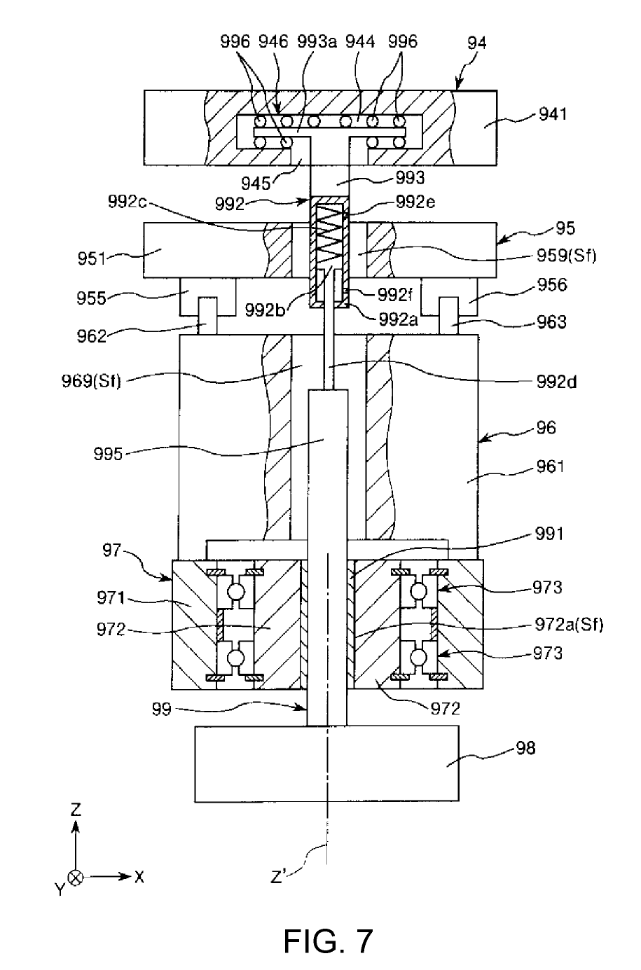

In the following explanation, a plane defined by the X axis and the Y axis is referred to as “XY plane”, a plane defined by the Y axis and the Z axis is referred to as “YZ plane”, and a plane defined by the X axis and the Z axis is referred to as “XZ plane”. In FIG. 7, some of the components included in the first hand unit 92 are omitted for convenience of explanation.

FIGS. 4 to 6 are plan views (with partial sections) of the first hand unit 92 viewed from different directions.

As shown in the figures, the first hand unit 92 includes a supporting section (a base section) 94 supported and fixed by the first hand-unit supporting section 913, a first moving section 95 supported by the supporting section 94 and capable of reciprocatingly moving in the X direction with respect to the supporting section 94, a second moving section 96 supported by the first moving section 95 and capable of reciprocatingly moving in the Y direction with respect to the first moving section 95, a pivoting section (a rotating section) 97 supported by the second moving section 96 and pivotable (rotatable) about the Z axis with respect to the second moving section 96, a shaft 99 provided in the pivoting section 97, a holding section 98 fixed to the shaft 99, a first piezoelectric actuator 200 configured to move the first moving section 95 with respect to the supporting section 94, a second piezoelectric actuator 300 configured to move the second moving section 96 with respect to the first moving section 95, and a third piezoelectric actuator (a piezoelectric actuator for the pivoting section) 400 configured to cause the pivoting section 97 to pivot with respect to the second moving section 96.

In the first hand unit 92, a position changing mechanism section 700 that performs positioning (correction of positions in the X direction and the Y direction and an angle about the Z axis) of the IC chip 100 is configured by the first moving section 95, the second moving section 96, the pivoting section 97, and the first, second, and third piezoelectric actuators 200, 300, and 400 that drive the sections.

A two-dimensional moving section 710 that performs positioning in the X and Y direction of the IC chip 100 is configured by the first moving section 95, the second moving section 96, and the first and second piezoelectric actuators 200 and 300 that drive the sections. With the two-dimensional moving section 710, it is possible to two-dimensionally correct the position of the IC chip 100 in the XY plane. Therefore, it is possible to perform more highly accurate positioning of the IC chip 100.

### Supporting Section

The supporting section 94 includes a base section 941 formed in a tabular shape having thickness in the Z direction and a pair of engaging sections 942 and 943 provided on the lower surface of the base section 941 and for guiding the first moving section 95 in the X direction. The pair of engaging sections 942 and 943 extend in the X direction and separate from each other in the Y direction. The configuration of the engaging sections 942 and 943 is not specifically limited. The engaging sections 942 and 943 in this embodiment respectively have grooves opened in the longitudinal direction of rails 952 and 953 explained below. In other words, the engaging sections 942 and 943 are configured by long sections having long grooves opened downward in the figure.

A space 944 opened to the lower surface of the base section 941 via a communication hole 945 is formed in the base section 941. A following mechanism 946 is formed in the space 944. The following mechanism 946 is explained later.

The supporting section 94 includes a contact section 947 configured to extend toward the Z direction (−) side from the base section 941 and come into contact with the first piezoelectric actuator 200. The contact section 947 extends to the second moving section 96. The contact section 947 is provided to be arranged in the Y direction with respect to the first moving section 95 and the second moving section 96. A lower surface 947a of the contact section 947 extends in the X direction. A projection 203a of the first piezoelectric actuator 200 is in contact with the lower surface 947a. It is desirable to apply, to the surface of the lower surface 947a, processing for increasing friction resistance between the surface of the lower surface 947a and the projection 203a or form a high friction layer on the surface of the lower surface 947a. In the following explanation, the lower surface 947a is referred to as “contact surface 947a”.

The supporting section 94 is configured as explained above, whereby it is possible to arrange the sections of the first hand unit 92 to further reduce spaces among the sections, in other words, arrange the sections closer to one another. Therefore, it is possible to realize a reduction in the size of the first hand unit 92.

A device mark 949 for performing positioning in the X and Y directions of the held IC chip 100 is fixed to the base section 941 of the supporting section 94 via a device-mark supporting section 948.

### First Moving Section

The first moving section 95 includes a base section 951 and a pair of rails 952 and 953 provided in the base section 951 and configured to engage with the engaging sections 942 and 943 of the supporting section 94. Consequently, the movement of the first moving section 95 in directions other than the X direction is regulated. The first moving section 95 smoothly and surely moves in the X direction.

The first moving section 95 includes a first fixing section 954 configured to extend toward the Z direction (−) side from the base section 951. The first piezoelectric actuator 200 is fixed to the first fixing section 954. The first fixing section 954 is formed in a tabular shape having breadth on the XZ plane and having thickness in the Y direction. The first fixing section 954 is provided in the Y direction with respect to the second moving section 96 (a base section 961). The first piezoelectric actuator 200 is fixed to the surface of the first fixing section 954.

The first piezoelectric actuator 200 is formed in a tabular shape and fixed to the first fixing section 954 to have thickness in the Y direction. The first piezoelectric actuator 200 is arranged in this way, whereby it is possible to suppress excess projection of the first piezoelectric actuator 200 to the outside and realize a reduction in the size of the first hand unit 92.

As explained above, the projection 203a of the first piezoelectric actuator 200 is in contact with the contact surface 947a of the contact section 947 of the supporting section 94.

The first moving section 95 includes a second fixing section 957 configured to extend toward the Z direction (−) side from the base section 951. The second piezoelectric actuator 300 is fixed to the second fixing section 957. The second fixing section 957 is formed in a tabular shape having breadth on the YZ plane and having thickness in the X direction. The second fixing section 957 is provided in the X direction with respect to the second moving section 96 (the base section 961). The second piezoelectric actuator 300 is fixed to the rear surface of the second fixing section 957.

The second piezoelectric actuator 300 is formed in a tabular shape and fixed to the second fixing section 957 to have thickness in the X direction. The second piezoelectric actuator 300 is arranged in this way, whereby it is possible to suppress projection of the second piezoelectric actuator 300 to the outside and realize a reduction in the size of the first hand unit 92.

A projection 303a of the second piezoelectric actuator 300 is in contact with a lower surface 965a of the contact section 965 provided in the second moving section 96.

By configuring the first moving section 95 as explained above, it is possible to arrange the sections of the first hand unit 92 to reduce spaces among the sections, in other words, arranged to be closer to one another. Therefore, it is possible to realize a reduction in the size of the first hand unit 92. The first piezoelectric actuator 200 and the second piezoelectric actuator 300 are fixed to the first moving section 95, whereby a degree of freedom of setting of the first piezoelectric actuator 200 and the second piezoelectric actuator 300 increases. Consequently, it is possible to realize a reduction in the size of the first hand unit 92. In particular, as in this embodiment, the first and second piezoelectric actuators 200 and 300 are arranged to be opposed to different side surfaces of the first moving section 95, whereby the effect becomes more conspicuous.

The first moving section 95 is configured as a so-called “self-propelled type” moved in the X direction with respect to the supporting section 94 by the driving of the first piezoelectric actuator 200 fixed to the first moving section 95. Therefore, it is possible to efficiently transmit a driving force of the first piezoelectric actuator 200 to the first moving section 95 and more smoothly and accurately move the first moving section 95 with respect to the supporting section 94. For example, compared with the first piezoelectric actuator 200 fixed to the supporting section 94 to which the first piezoelectric actuator 200 moves relatively (a configuration of a so-called “fixed type”), a degree of freedom of arrangement of the first piezoelectric actuator 200 increases. Therefore, it is possible to realize a reduction in the size of the first hand unit 92.

The first moving section 95 includes a pair of engaging sections (guiding sections) 955 and 956 for guiding the second moving section 96 in the Y direction. The pair of engaging sections 955 and 956 extend in the Y direction and separate from each other in the X direction. The configuration of the engaging sections 955 and 956 is not specifically limited. The engaging sections 955 and 956 in this embodiment respectively have grooves opened in the longitudinal direction of rails 962 and 963 explained below. In other words, the engaging sections 955 and 956 are configured by long sections having long grooves opened downward in the figure.

### Second Moving Section

The second moving section 96 includes a base section 961 having a columnar shape and a pair of rails 962 and 963 provided in the base section 961 and configured to engage with the engaging sections 955 and 956 of the first moving section 95. Consequently, the movement of the second moving section 96 in directions other than the Y direction is regulated. The second moving section 96 smoothly and surely moves in the Y direction. A contact section 965 that comes into contact with the second piezoelectric actuator 300 is provided in the base section 961. The contact section 965 is provided such that a lower surface 965a thereof comes into contact with the projection 303a of the second piezoelectric actuator 300. The lower surface 965a extends in the Y direction, which is a moving direction of the second moving section 96. In the following explanation, the lower surface 965a is referred to as “contact surface 965a” as well.

The “columnar shape” refers to a shape having breadth on a predetermined plane (e.g., the XY plane, the YZ plane, or the ZX plane) and having height in a direction orthogonal to the predetermined plane. More specifically, for example, when the columnar shape is a shape having breadth on the XY plane and having height in the Z direction, the columnar shape refers to a shape having length in the Z direction longer than lengths in both the X and Y directions. The shape in plan view (a cross-sectional shape) of the base section 961 is not specifically limited as long as the shape satisfies the above.

A surface 961a further recessed than the other portions is formed in the base section 961 of the second moving section 96. The third piezoelectric actuator 400 for causing the pivoting section 97 to pivot is fixed to the surface 961a. The surface 961a is formed by the YZ plane. The tabular third piezoelectric actuator 400 is fixed to the surface 961a to have thickness in the X direction. The third piezoelectric actuator 400 is arranged in this way, whereby it is possible to suppress excess projection of the third piezoelectric actuator 400 to the outside. Therefore, it is possible to realize a reduction in the size of the first hand unit 92. Further, a degree of freedom of the arrangement of the third piezoelectric actuator 400 increases.

The first, second, and third piezoelectric actuators 200, 300, and 400 are provided along the side surfaces of the second moving section 96 (the two-dimensional moving section 710) and to surround the side surfaces. The three piezoelectric actuators 200, 300, and 400 are arranged in this way, whereby it is possible to arrange the first, second, and third piezoelectric actuators 200, 300, and 400 closer to the center (the shaft 99), i.e., arrange the sections of the first hand unit 92 close to one another. Therefore, it is possible to realize a reduction in the size of the first hand unit 92.

### Pivoting Section

As shown in FIG. 5, the pivoting section 97 is located below (the Z direction (−) side of) the second moving section 96. The pivoting section 97 includes a tubular supporting section 971 fixed to the lower end of the base section 961 of the second moving section 96, a pivoting body (a rotating body) 972 provided on the inner side of the supporting section 971 and coaxially with the supporting section 971, a plurality of (e.g., two) ring-like bearings 973 provided between the supporting section 971 and the pivoting body 972, and a fixing section 974 for fixing the bearing 973.

The plurality of bearings 973 are provided along the Z direction. Each of the bearings 973 includes an outer ring 973a fixed to the inner circumferential surface of the supporting section 971, an inner ring 973b fixed to the outer circumferential surface of the pivoting body 972 and arranged to be opposed to the outer ring 973a, and a ball 973c located between the outer ring 973a and the inner ring 973b and held by the rings. The ball 973c is provided to be freely rotatable between the outer ring 973a and the inner ring 973b.

The fixing section 974 includes a bearing 973 (973′) located on the upper side in the Z direction, a tubular collar 974a provided to form a gap between the collar 974a and a bearing 973 (973″) located on the lower side, an outer ring retainer 974b and an inner ring retainer 974c provided to hold the bearing 973′ between the retainers and the collar 974a, and an outer ring retainer 974d and an inner ring retainer 974e provided to hold a bearing 973″ between the retainers and the collar 974a.

With the pivoting section 97 having such a configuration, it is possible to regulate displacement in the Z direction and displacement in the X direction and the Y direction of the pivoting body 972 while allowing the pivoting body 972 to pivot (rotate) about the Z axis with respect to the supporting section 971.

The pivoting body 972 is formed in a cylindrical shape having an axis in the Z direction. A through-hole 972a that pierces through the upper surface and the lower surface of the pivoting body 972 is formed on the inside of the pivoting body 972. In other words, the pivoting body 972 is formed in a hollow structure having a hollow portion on the inside. By configuring the pivoting body 972 in this way, it is possible to insert another member through the pivoting body 972 and arrange another member in the pivoting body 972. Therefore, a degree of freedom of design of the first hand unit 92 increases and it is possible to realize a reduction in the size of the first hand unit 92. In this embodiment, the shaft 99 is inserted through the through-hole 972a as the other member.

A projection 403a of the third piezoelectric actuator 400 fixed to the second moving section 96 is in contact with a position present on an upper surface 972b of the pivoting body 972 and deviating from a pivot axis Z′ of the pivoting body 972. The pivoting body 972 pivots with respect to the supporting section 971 (the second moving section 96) according to the driving of the third piezoelectric actuator 400.

The third piezoelectric actuator 400 is provided in the position deviating from (a position separated from) the pivot axis Z′ of the pivoting body 972 in this way, whereby the insertion of the shaft 99 through the through-hole 972a is not obstructed. Therefore, a degree of freedom of design of the first hand unit 92 increases. It is possible to realize a reduction in the size of the first hand unit 92.

### Shaft

As shown in FIG. 7, the shaft 99 includes a shaft body (an axis-direction moving section) 995, a bearing 991 configured to bear the shaft body 995, a cylinder 992 connected to the shaft body 995, and a cylinder supporting section 993 configured to support the cylinder 992.

The shaft body 995 is fixed to the pivoting body 972 via the bearing 991. In this embodiment, the shaft body 995 and the bearing 991 configure a ball spline. The bearing 991 is a spline boss fit in the through-hole 972a of the pivoting body 972. The shaft body 995 is a spline shaft supported in a state in which pivoting (rotation) about the Z axis is prevented and supported slidably in the Z direction with respect to the bearing (spline boss) 991. By configuring the shaft body 995 in this way, the shaft body 995 can pivot integrally with the pivoting body 972 but the shaft body 995 alone cannot pivot with respect to the pivoting body 972. Therefore, undesired pivoting about the Z axis of the IC chip 100 held by the holding section 98 is prevented. It is possible to more accurately perform positioning of the IC chip 100.

The cylinder 992 is set above the shaft body 995. Since the cylinder 992 is provided, as explained below, when the IC chip 100 gripped by the first hand unit 92 is pressed against the individual test socket 61 at predetermined test pressure, the shaft body 995 can receive the pressure by relatively moving in the Z direction (+) side.

The configuration of the cylinder 992 is not specifically limited. For example, an air pressure cylinder can be used as the cylinder 992. The cylinder 992 includes a cylinder tube 992a, a piston 992b provided to be slidable in the cylinder tube 992a, and a spring 992c configured to urge the piston 992b downward. In the cylinder tube 992a, a port 992e for letting the air in and out of an inner space partitioned by the piston 992b and a port 992f for letting the air in and out of the other inner space are formed. A shaft 992d extends from the piston 992b. The shaft 992d and the shaft body 995 are coaxially coupled.

The cylinder tube 992a is supported by a columnar cylinder supporting section 993 located above the cylinder tube 992a and provided coaxially with the shaft body 995. The distal end portion of the cylinder supporting section 993 is located in the space 944 in the supporting section 94 via the communication hole 945 formed in the supporting section 94. The distal end portion of the cylinder supporting section 993 includes a flange 993a projecting in the circumferential direction.

A plurality of balls 996 are provided between the upper and lower surfaces of the flange 993a and the inner surface of the supporting section 94 without a gap in the up-down direction. Consequently, it is possible to cause the cylinder supporting section 993 to smoothly pivot about the Z axis with respect to the supporting section 94 while preventing displacement in the Z direction of the cylinder supporting section 993 with respect to the supporting section 94.

The outer diameter of the communication hole 945 is formed larger than the outer diameter of the cylinder supporting section 993. The outer diameter of the space 944 is formed larger than the flange 993a. Consequently, the cylinder supporting section 993 is movable in the XY plane direction with respect to the supporting section 94. Consequently, it is possible to prevent the movement of the shaft body 995 in the XY plane by the movement of the first moving section 95 with respect to the supporting section 94 and the movement of the second moving section 96 with respect to the first moving section 95 from being obstructed by the contact of the cylinder supporting section 993 and the communication hole 945. In other words, the communication hole 945 is set to a size for not obstructing the movement of the shaft 99 in the XY plane.

The following mechanism 946 is configured by such a configuration. The pivoting and the movement of the shaft body 995 (the pivoting body 972) is not obstructed.

The shaft 99 is explained above. As explained above, the distal end portion of the shaft 99 pierces through the pivoting section 97 and is fixed to the pivoting section 97 and the proximal end portion of the shaft 99 enters the supporting section 94 (reaches the supporting section 94). In other words, a shaft disposing space Sf that can allow the arrangement and the displacement in the XY direction of the shaft 99 is formed in the first moving section 95 and the second moving section 96 among the members located between the supporting section 94 and the holding section 98. A through-hole for inserting and supporting the shaft 99 is formed in the pivoting section 97.

The shaft disposing space Sf may be formed in any manner as long as the shaft 99 can be arranged therein. For example, a through-hole (including a groove opened to a side surface) piercing through the upper surface and the lower surface of the first moving section 95 may be formed in the first moving section 95 (the same applies to the second moving section 96) and an inner space of the through-hole may be set as the shaft disposing space Sf. The first moving section 95 may be formed to avoid the shaft disposing space Sf. A space located on the outer side (the side direction) of the first moving section 95 may be set as the shaft disposing space Sf.

In this embodiment, a through-hole 959 piercing through the upper surface and the lower surface of the first moving section 95 is formed in the first moving section 95. An inner space of the through-hole 959 forms the shaft disposing space Sf. Similarly, a through-hole 969 piercing through the upper surface and the lower surface of the second moving section 96 is formed in the second moving section 96. An inner space of the through-hole 969 forms the shaft disposing space Sf. The pivoting section 97 includes the through-hole 972a formed in the pivoting body 972. The shaft 99 is inserted through the through-hole 972a and supported.

### Holding Section

The holding section 98 has a function of holding the IC chip 100. The holding section 98 is fixed to the distal end of the shaft 99 (the shaft body 995). In other words, the holding section 98 is supported by the pivoting section 97 via the shaft 99 and provided to be pivotable with respect to the second moving section 96 integrally with the pivoting body 972.

The holding section 98 includes an attracting surface 981 opposed to the IC chip 100, an attracting hole 982 opened to the attracting surface 981, and a decompressing pump 983 configured to decompress the inside of the attracting hole 982. In a state in which the attracting surface 981 is set in contact with the IC chip 100 to close the attracting hole 982, when the inside of the attracting hole 982 is decompressed by the decompressing pump 983, the IC chip 100 can be attracted to and held on the attracting surface 981. Conversely, when the decompressing pump 983 is stopped and the inside of the attracting hole 982 is opened, the IC chip 100 can be released.

### Piezoelectric Actuator

The first, second, and third piezoelectric actuators 200, 300, and 400 are now explained. Since the first, second, and third piezoelectric actuators 200, 300, and 400 have the same configuration, the first piezoelectric actuator 200 is representatively explained below. Explanation of the second and third piezoelectric actuators 300 and 400 is omitted.

As shown in FIG. 8, the first piezoelectric actuator 200 is formed in a substantially rectangular tabular shape.

The “tabular shape” refers to a shape having breadth on a predetermined plane (e.g., the XY plane, the YZ plane, or the ZX plane) and having thickness in a direction orthogonal to the predetermined plane, in other words, a flat shape on the predetermined plane. Further, for example, when the tabular shape is a shape having breadth on the XY plane and having thickness in the Z direction, the tabular shape refers to a shape having length in the Z direction shorter than lengths in both the X and Y directions. The shape in a plan view of the first piezoelectric actuator 200 is not specifically limited as long as the shape satisfies the above. Unevenness may be formed on the surfaces (two principal planes in a front and rear relation) of the first piezoelectric actuator 200.

The first piezoelectric actuator 200 is configured by laminating, from the upper side in FIG. 8, four electrodes 201a, 201b, 201c, and 201d, a tabular piezoelectric element 202, a reinforcing plate 203, a tabular piezoelectric element 204, and four tabular electrodes 205a, 205b, 205c, and 205d (in FIG. 8, the electrodes 205a, 205b, 205c, and 205d are not shown and only the reference signs are shown in parentheses) in this order.

The piezoelectric elements 202 and 204 are formed in a tabular shape and fixedly attached to both surfaces of the reinforcing plate 203. The piezoelectric elements 202 and 204 expand and contract in the longitudinal direction thereof (the direction of the long sides) when an alternating-current voltage is applied thereto. A material forming the piezoelectric elements 202 and 204 is not specifically limited. Various materials such as lead zirconate titanate (PZT), quartz, lithium niobate, barium titanate, lead titanate, lead metaniobate, polyvinylidene fluoride, lead zinc niobate, and scandium lead niobate can be used.

In the first piezoelectric actuator 200, the piezoelectric element 202 is substantially equally divided into four rectangular regions. The electrodes 201a, 201b, 201c, and 201d formed in a rectangular shape are respectively set in the divided regions. Similarly, the piezoelectric element 204 is divided into four regions. The electrodes 205a, 205b, 205c, and 205d formed in a rectangular shape are respectively set in the divided regions. The electrode 201a and the electrode 205a, the electrode 201b and the electrode 205b, the electrode 201c and the electrode 205c, and the electrodes 201d and the electrode 205d are respectively arranged to be opposed to each other in the thickness direction.

All of the electrodes 201a and 201c on one diagonal line and the electrodes 205a and 205c located on the rear side of the electrodes 201a and 201c are electrically connected. Similarly, all of the electrodes 201b and 201d on the other diagonal line and the electrodes 205b and 205d located on the rear side of the electrodes 201b and 201d are electrically connected.

The reinforcing plate 203 has a function of reinforcing the entire first piezoelectric actuator 200 and prevents the first piezoelectric actuator 200 from being damaged by excessive amplitude, external force, and the like. The projection (a driving-force generating section) 203a is integrally formed at one end in the longitudinal direction of the reinforcing plate 203. As explained above, the projection 203a comes into contact with the contact surface 947a of the contact section 947 included in the supporting section 94. The projection 203a may be formed of another member having a large coefficient of friction or another member excellent in abrasion resistance.

A material forming the reinforcing plate 203 is not specifically limited. However, the material is desirably various metal materials such as stainless steel, aluminum or an aluminum alloy, titanium or a titanium alloy, and copper or a copper alloy.

The reinforcing plate 203 is desirably thinner than the piezoelectric elements 202 and 204. Consequently, it is possible to cause the first piezoelectric actuator 200 to oscillate at high efficiency.

The reinforcing plate 203 also has a function of a common electrode for the piezoelectric elements 202 and 204. Specifically, an alternating-current voltage is applied to the piezoelectric element 202 by a predetermined electrode among the electrodes 201a, 201b, 201c, and 201d and the reinforcing plate 203. An alternating-current voltage is applied to the piezoelectric element 204 by a predetermined electrode among the electrodes 205a, 205b, 205c, and 205d and the reinforcing plate 203.

In a state in which the projection 203a of the first piezoelectric actuator 200 is in contact with the contact surface 947a of the supporting section 94, the electrodes 201a, 201c, 205a, and 205c are energized and an alternating-current voltage is applied between the electrodes 201a, 201c, 205a, and 205c and the reinforcing plate 203. Then, as shown in FIG. 9, portions of the first piezoelectric actuator 200 corresponding to the electrodes 201a, 201c, 205a, and 205c repeatedly expand and contract in an arrow “a” direction. Consequently, the projection 203a of the first piezoelectric actuator 200 is displaced in an oblique direction indicated by an arrow “b”, i.e., reciprocatingly moves in the XY plane or, as indicated by an arrow “c”, is displaced substantially along an ellipse, i.e., elliptically moves. When the portions of the first piezoelectric actuator 200 corresponding to the electrodes 201a, 201c, 205a, and 205c expand, a frictional force (a pressing force) is generated between the contact surface 947a and the projection 203a. The first moving section 95 moves to the X direction (−) side with the repeatedly generated frictional force.

Conversely, the electrodes 201b, 201d, 205b, and 205d located on the diagonal line of the first piezoelectric actuator 200 are energized and an alternating-current voltage is applied between the electrodes 201b, 201d, 205b, and 205d and the reinforcing plate 203. Then, as shown in FIG. 10, portions of the first piezoelectric actuator 200 corresponding to the electrodes 201b, 201d, 205b, and 205d repeatedly expand in an arrow “a” direction. Consequently, the projection 203a of the first piezoelectric actuator 200 is displaced in an oblique direction indicated by an arrow “b”, i.e., reciprocatingly moves in the XY plane or, as indicated by an arrow “c”, is displaced substantially along an ellipse, i.e., elliptically moves. When the portions of the first piezoelectric actuator 200 corresponding to the electrodes 201b, 201d, 205b, and 205d expand, a frictional force is generated between the contact surface 947a and the projection 203a. The first moving section 95 moves to the X direction (+) side with the repeatedly generated frictional force.

When the first piezoelectric actuator 200 is stopped, the contact surface 947a of the contact section 947 and the projection 203a of the first piezoelectric actuator 200 are in contact with each other with a sufficient frictional force. Therefore, it is possible to effectively prevent undesired movement of the first moving section 95 with respect to the supporting section 94 when the first piezoelectric actuator 200 is not driven.

The first piezoelectric actuator 200 is desirably provided in a state in which the first piezoelectric actuator 200 is urged to the contact surface 947a side. Consequently, the frictional force generated between the projection 203a and the contact surface 947a increases. It is possible to more smoothly and surely move the first moving section 95 in the X direction with respect to the supporting section 94.

A mechanism for urging the first piezoelectric actuator 200 is not specifically limited and may be any biasing member including a spring member such as a leaf spring or a coil spring. For example, the urging mechanism can be configured as explained below.

As shown in FIG. 8, a pair of arm sections 203b having elasticity are integrally formed on both sides of the reinforcing late 203. Each of the arm sections 203b is provided to project in a direction substantially perpendicular to the longitudinal direction thereof. A fixing section 203c is integrally formed at the distal end portion of the arm section 203b. A hole for screwing is formed in the fixing section 203c.

The first piezoelectric actuator 200 is screwed and fixed to the first moving section 95 in the fixing section 203c. Consequently, the first piezoelectric actuator 200 can freely oscillate. The first piezoelectric actuator 200 is urged to the contact surface 947a side by an elastic force (a restoring force) of the arm sections 203b. The projection 203a is brought into press contact with (pressed against or abuts) the contact surface 947a by the urging force.

The configuration of the first piezoelectric actuator 200 is explained above.

In the same manner as the driving of the first piezoelectric actuator 200 explained above, the second piezoelectric actuator 300 is driven as explained below. As explained above, the projection 303a of the second piezoelectric actuator 300 is in contact with the contact surface 965a of the contact section 965 included in the second moving section 96. When the second piezoelectric actuator 300 is driven in this state, the projection 303a reciprocatingly moves or elliptically moves in the YZ plane. Consequently, a frictional force is generated between the contact surface 965a of the contact section 965 and the projection 303a. The second moving section 96 moves to the Y direction side with respect to the first moving section 95.

As shown in FIG. 6, the first and second piezoelectric actuators 200 and 300 face in the same direction (the upper side). Specifically, the projection (the driving-force generating section) 203a of the first piezoelectric actuator 200 and the projection (the driving-force generating section) 303a of the second piezoelectric actuator 300 project to the same side (the upper side) in the Z axis direction. The projection 203a and the projection 303a are respectively in contact with the contact surfaces 947a and 965a from below. The first and second piezoelectric actuators 200 and 300 are arranged in the same direction in this way. Consequently, it is possible to compactly arrange the first and second piezoelectric actuators 200 and 300 and realize a further reduction in the size of the first hand unit 92.

The third piezoelectric actuator 400 is driven as explained below. As explained above, the projection 403a of the third piezoelectric actuator 400 is in contact with the position present on the upper surface 972b of the pivoting body 972 and deviating from the pivot shaft Z′. When the third piezoelectric actuator 400 is driven in this state, the projection 403a reciprocatingly moves or elliptically moves in the YZ plane. Consequently, a frictional force is generated between the upper surface 972b and the projection 403a. The pivoting body 972 pivots about the pivot axis Z′ with respect to the second moving section 96.

The configuration of the first hand unit 92 is briefly explained above. With the first hand unit 92 having the configuration explained above, the first moving section 95, the second moving section 96, and the pivoting section 97 are respectively driven by the piezoelectric actuators 200, 300, and 400. Therefore, it is possible to realize a reduction in the size of the first hand unit 92.

Specifically, in the past, a motor has been used as a driving source. However, when the motor is used, members such as gears (a rack gear, a pinion gear, etc.) and a shaft for converting a rotational motion of the motor into a linear motion are separately necessary. Therefore, it is difficult to realize a reduction in the size of the apparatus. On the other hand, when the piezoelectric actuators 200, 300, and 400 are used as the driving sources as in the first hand unit 92, the piezoelectric actuators 200, 300, and 400 are thin (small) compared with the motor and directly drive the first moving section 95, the second moving section 96, and the pivoting section 97 without an intervening member. Therefore, it is possible to realize a reduction in the size of the apparatus compared with the configuration of the past.

If a reduction in the size of the first hand unit 92 can be realized as explained above, it is possible to array a plurality of the first hand units 92 at a narrower pitch. Therefore, it is possible to increase the number of the first hand units 92 that can be arranged in a predetermined region and increase the number of the individual test sockets 61 as well according to the increase in the number of the first hand units 92. Therefore, the number of IC chips 100 that can be tested at a time increases. It is possible to more efficiently perform the test of the IC chips 100 while suppressing an increase in the size of the apparatus.

As explained above, the first hand-unit supporting section 913 that supports the first hand unit 92 is provided to be movable in the Y direction. When the first hand-unit supporting section 913 moves in the Y direction, an inertial force in the Y direction is applied to the first hand unit 92. Undesired movement of the second moving section 96, which is provided to be movable in the Y direction, with respect to the first moving section 95 is regulated by the contact (the friction force) with the second piezoelectric actuator 300. However, when the inertial force is large, it is likely that the second moving section 96 moves with respect to the first moving section 95 resisting the friction force. Since the inertial force increases as a total weight of the second moving section 96 and the members supported by the second moving section 96 increases, it is desirable to reduce the members supported by the second moving section 96 as much as possible. Therefore, in the first hand unit 92 according to this embodiment, the first moving section 95 regulated from in the Y direction is located above the second moving section 96 (the first moving section 95 is caused to support the second moving section 96), whereby the number of the members supported by the second moving section 96 is reduced. Therefore, it is possible to effectively suppress undesired deviation of the second moving section 96 due to the inertial force explained above.

The first hand unit 92 performs positioning (visual alignment) of the held IC chip 100 as explained below. The IC chip 100 not tested yet stored in the tray 42 is held by the holding section 98. While the first hand unit 92 moves from a position right above the tray 42 to a position right above the test socket 6, the first hand unit 92 passes a position right above the first camera 600. When the first hand unit 92 passes the position right above the first camera 600, the first camera 600 picks up an image to capture the IC chip 100 held by the first hand unit 92 and the device mark 949 included in the first hand unit 92. Image data obtained by the image pickup is transmitted to the control device 10 and subjected to image recognition processing by the control device 10.

Specifically, in the image recognition processing, the control device 10 applies predetermined processing to the image data acquired from the first camera 600 and calculates relative positions and relative angles of the device mark 949 and the IC chip 100. The control device 10 compares the calculated relative positions and relative angles with reference positions and reference angles indicating a proper positional relation between the device mark 949 and the IC chip 100 and calculates a “deviated position amount” that occurs between the relative positions and the reference positions and a “deviated angle amount” that occurs between the relative angles and the reference angles. The reference positions and the reference angles refer to a position where the external terminals of the IC chip 100 are suitably connected to the probe pins 62 of the individual test socket 61 when the first hand unit 92 is arranged in a starting point position for test set in advance.

The control device 10 drives the first, second, and third piezoelectric actuators 200, 300, and 400 as desired on the basis of the calculated deviated position amount and the calculated deviated angle amount and corrects the position and the posture (the angle) of the IC chip 100 such that the relative positions and the relative angles coincide with the reference positions and the reference angles.

Specifically, when the deviated position amount occurs between the relative positions and the reference positions, the control device 10 drives the first piezoelectric actuator 200 to move the first moving section 95 in the X direction with respect to the supporting section 94 and drives the second piezoelectric actuator 300 to move the second moving section 96 in the Y direction with respect to the first moving section 95 or move one of the first and second moving sections 95 and 96 to thereby match the relative positions to the reference positions. When the deviated angle amount occurs between the relative angles and the reference angles, the control device 10 drives the third piezoelectric actuator 400 to cause the pivoting section 97 (the pivoting body 972) to pivot about the pivot axis Z′ with respect to the second moving section 96 to thereby match the relative positions to the reference positions. The positioning of the held IC chip 100 can be performed by the control explained above.

The control device 10 is configured to be capable of controlling the driving of the four first hand units 92 independently for the first hand units 92. Consequently, it is possible to perform the positioning (position correction) of the four IC chips 100, which are held by the first hand units 92, independently for the respective IC chips 100.

Positioning of the IC chip 100 by the second hand unit 93 is the same as the positioning by the first hand unit 92 explained above except that the second camera 500 is used instead of the first camera 600. Therefore, an explanation of the positioning by the second hand unit 93 is omitted.

### Collection Robot

The collection robot 8 is a robot for transferring, to the collection tray 3, the tested IC chips 100 stored in the tray 43 included in the first shuttle 4 and the tray 53 included in the second shuttle 5.

The collection robot 8 has a configuration that is the same as the configuration of the supply robot 7. Specifically, the collection robot 8 includes a supporting frame 82 supported by the pedestal 11, a moving frame (a Y-direction moving frame) 83 supported by the supporting frame 82 and capable of reciprocatingly moving in the Y direction with respect to the supporting frame 82, a hand-unit supporting section (an X-direction moving frame) 84 supported by the moving frame 83 and capable of reciprocatingly moving in the X direction with respect to the moving frame 83, and a plurality of hand units 85 supported by the hand-unit supporting section 84. The configurations of these sections are the same as the configurations of the corresponding sections of the supply robot 7. Therefore, explanation of the configurations is omitted.

The collection robot 8 performs conveyance of the IC chips 100 from the trays 43 and 53 to the collection tray 3. The conveyance of the IC chips 100 from the trays 43 and 53 to the collection tray 3 is performed by the same method. Therefore, the conveyance of the IC chips 100 from the tray 43 is representatively explained below.

First, the first shuttle 4 is moved to the X direction (+) side and the tray 43 is arranged in the Y direction with respect to the collection tray 3. Subsequently, the moving frame 83 is moved in the Y direction and the hand-unit supporting section 84 in the X direction to locate the hand units 85 on the tray 43. The holding sections of the hand units 85 are lowered and brought into contact with the IC chips 100 on the supply tray 2 to cause the holding sections to hold the IC chips 100.

Subsequently, the holding sections of the hand-unit supporting section 84 are lifted to remove the held IC chips 100 from the tray 43. The moving frame 83 is moved in the Y direction and the hand-unit supporting section 84 is moved in the X direction to locate the hand units 85 on the collection tray 3. The holding sections of the hand-unit supporting section 84 are lowered to arrange the IC chips 100 held by the holding sections in the pockets 31 of the collection tray 3. The attracted state of the IC chips 100 is released to release the IC chips 100 from the holding sections.

Consequently, the conveyance (the transfer) of the IC chips 100 from the tray 43 to the collection tray 3 is completed.

Among the tested IC chips 100 stored in the tray 43, defective products that cannot show predetermined electrical characteristics are sometimes present. Therefore, for example, two collection trays 3 may be prepared, one of which is used as a tray for storing quality products that satisfy the predetermined electrical characteristics and the other of which is used as a tray for collecting the defective products. When one collection tray 3 is used, a predetermined pocket 31 may be used as a pocket for storing the defective products. Consequently, it is possible to clearly distinguish the quality products and the defective products.

In such a case, for example, when three of four IC chips 100 held by the four hand units 85 are quality products and the remaining one is a defective product, the collection robot 8 conveys the three quality products to the collection tray for quality products and conveys the one defective product to the collection tray for defective products. Since the driving of the hand units 85 (the attraction of the IC chips 100) is performed independently for the hand units 85, such an operation can be easily performed.

### Control Device

The control device 10 includes a driving control section 102 and a test control section 101. The driving control section 102 controls, for example, the movement of the supply tray 2, the collection tray 3, the first shuttle 4, and the second shuttle 5 and the mechanical driving of the supply robot 7, the collection robot 8, the test robot 9, the first camera 600, the second camera 500, and the like. The test control unit 101 performs a test of the electrical characteristics of the IC chips 100 arranged on the test socket 6 on the basis of a computer program stored in a memory (not-shown).

The configuration of the test apparatus 1 is explained above.

### Test Method by the Test Apparatus

A test method for the IC chips 100 by the test apparatus 1 is explained. A test method, in particular, a conveying procedure for the IC chips 100 explained below is an example. The test method by the test apparatus 1 is not limited to the test method explained below.

### Step 1

First, as shown in FIG. 11, the supply tray 2 on which the IC chips 100 are stored in the pockets 21 is conveyed to the inside of the region S. The first and second shuttles 4 and 5 are moved to the X direction (−) side to arrange the trays 42 and 52 on the Y direction (+) side with respect to the supply tray 2.

### Step 2

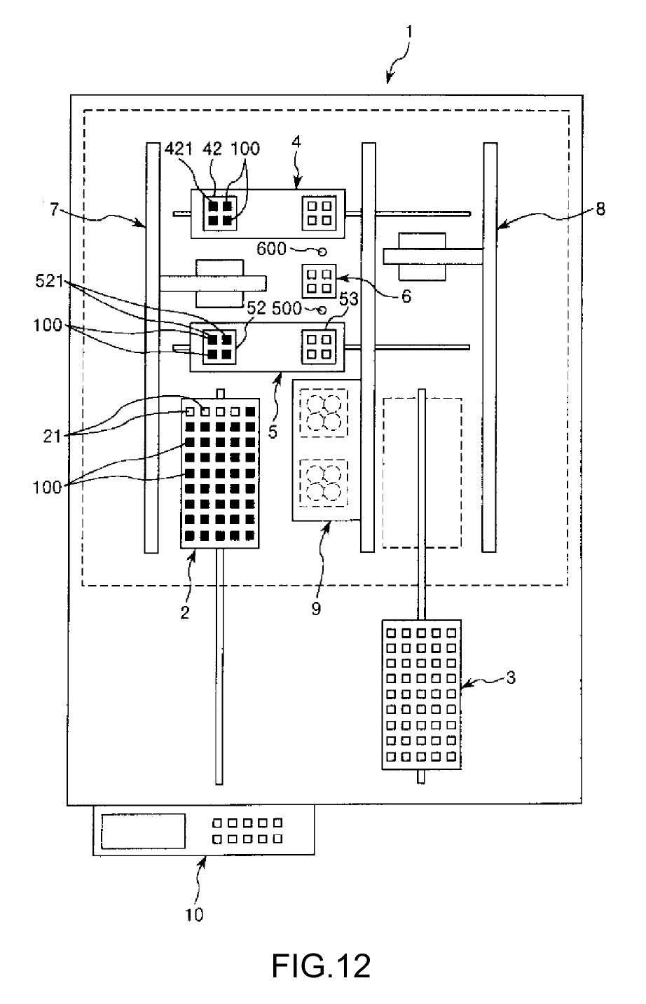

Subsequently, as shown in FIG. 12, the IC chips 100 stored in the supply tray 2 are transferred to the trays 42 and 52 by the supply robot 7. The IC chips 100 are stored in the pockets 421 and 521 of the trays 42 and 52.

### Step 3

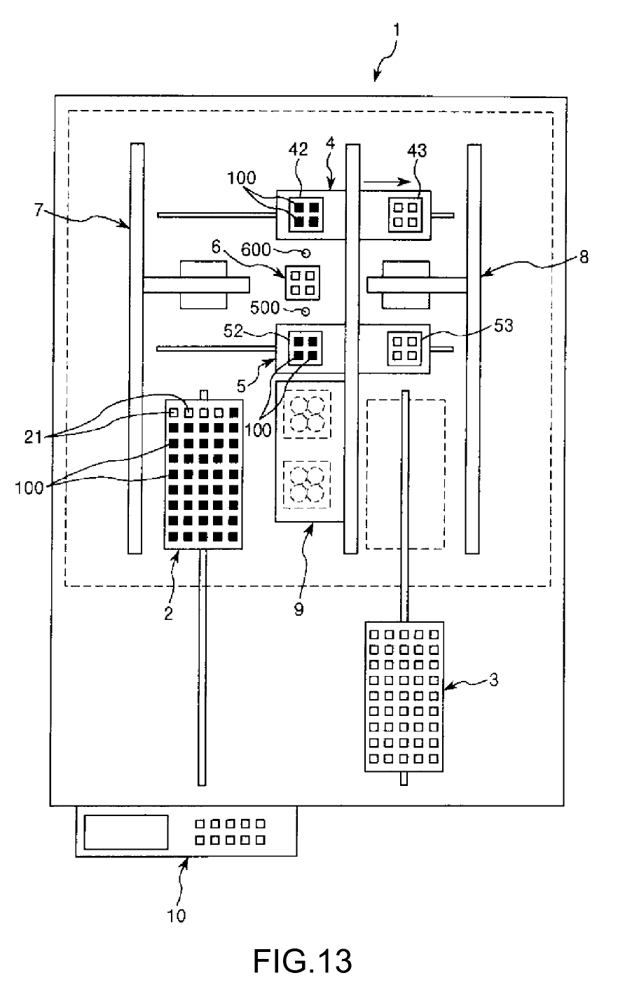

Subsequently, as shown in FIG. 13, both the first and second shuttles 4 and 5 are moved to the X direction (+) side to arrange the tray 42 on the Y direction (+) side with respect to the test socket 6 and arrange the tray 52 on the Y direction (−) side with respect to the test socket 6.

### Step 4

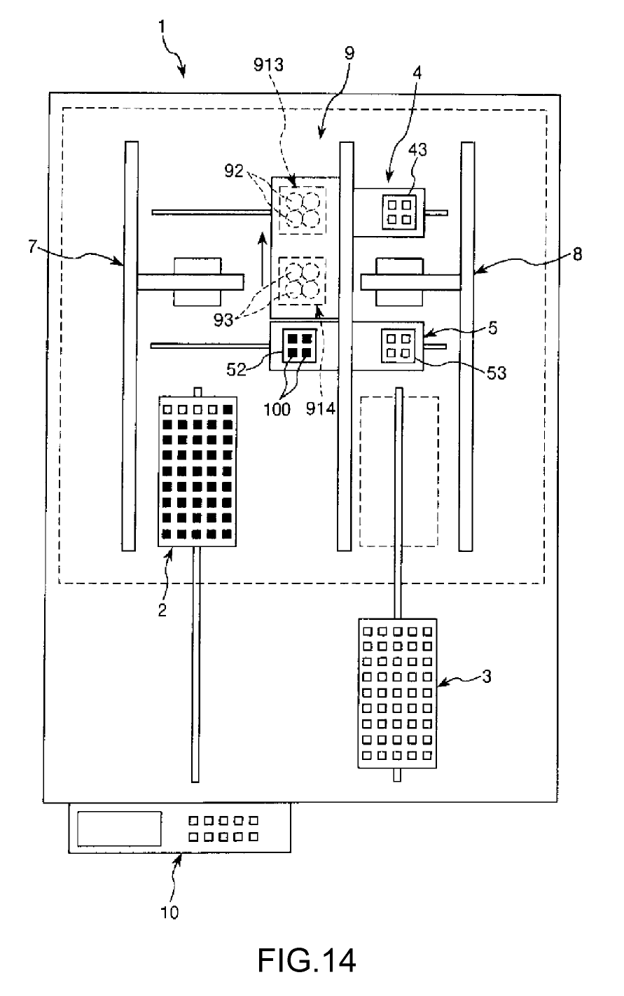

Subsequently, as shown in FIG. 14, the first and second hand-unit supporting sections 913 and 914 are integrally moved to the Y direction (+) side to locate the first hand-unit supporting section 913 right above the tray 42 and locate the second hand-unit supporting section 914 right above the test socket 6.

Thereafter, the first hand units 92 hold the IC chips 100 stored in the tray 42. Specifically, first, the first hand units 92 move to the Z direction (−) side to attract and hold the IC chips 100 stored in the tray 42. Subsequently, the first hand units 92 move to the Z direction (+) side. Consequently, the IC chips 100 held by the first hand units 92 are taken out from the tray 42.

### Step 5

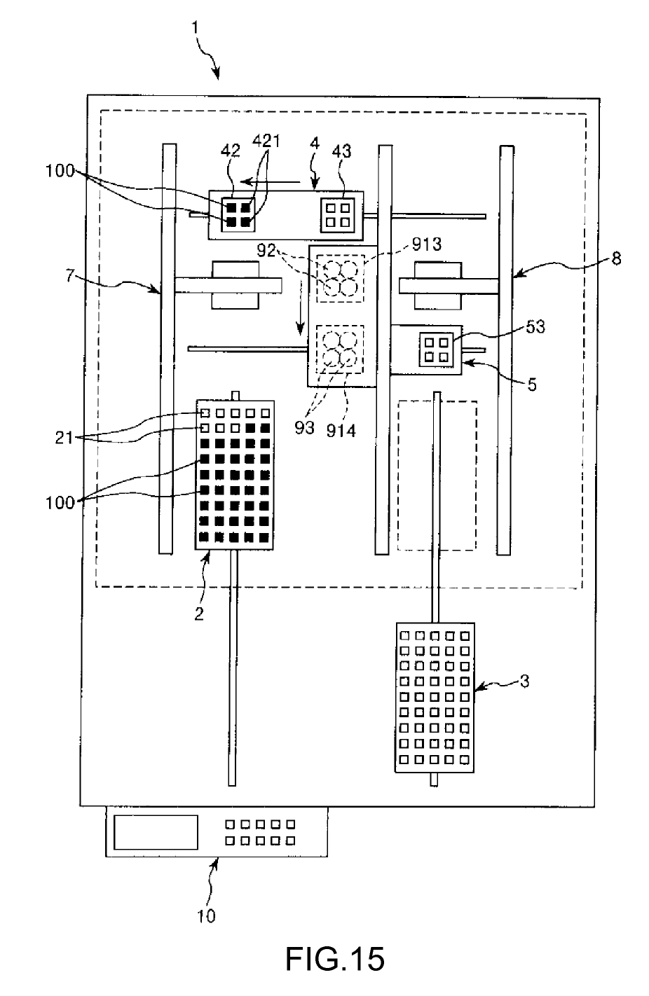

Subsequently, as shown in FIG. 15, the first and second hand-unit supporting sections 913 and 914 are integrally moved to the Y direction (−) side to locate the first hand-unit supporting section 913 right above the test socket 6 (a starting point position for test) and locate the second hand-unit supporting section 914 right above the tray 52. During the movement, when the first hand-unit supporting section 913 (the first hand units 92) passes right above the first camera 600, the first camera 600 picks up an image to capture the IC chips 100 held by the first hand units 92 and the device marks 949 of the first hand units 92. The control device 10 performs, on the basis of image data obtained by the image pickup, positioning (visual alignment) of the IC chips 100 independently for the IC chips 100 according to the method explained above. The positioning (the visual alignment) mechanism performing recognition of relative positions of the individual test sockets 61 and the socket marks, recognition of relative positions of the socket marks and the device marks 949, and recognition of relative positions of the device marks 949 and the IC chips 100 and positioning of the individual test sockets 61, the socket marks, the device marks 949, and the IC chips 100. As a result, positioning of the individual test sockets 61 and the IC chips 100 is performed.

In parallel to the movement of the first and second hand-unit supporting sections 913 and 914 and the positioning of the IC chips 100, work explained below is performed. First, the first shuttle 4 is moved to the X direction (−) side to arrange the tray 43 in the Y direction with respect to the test socket 6 and arrange the tray 42 in the Y direction with respect to the supply tray 2. Subsequently, the IC chips 100 stored in the supply tray 2 are transferred to the tray 42 by the supply robot 7. The IC chips 100 are stored in the pockets 421 of the tray 42.

### Step 6

Subsequently, the first hand-unit supporting section 913 is moved to the Z direction (−) side to arrange the IC chips 100 held by the first hand units 92 in the individual test sockets 61 of the test socket 6. The IC chips 100 are pressed against the individual test sockets 61 at predetermined test pressure (pressure). Consequently, the external terminals of the IC chips 100 and the probe pins 62 provided in the individual test sockets 61 are electrically connected. In this state, a test of the electrical characteristics is carried out for the IC chips 100 in the individual test sockets 61 by the test control section 101 of the control device 10. When the test ends, the first hand-unit supporting section 913 is moved to the Z direction (+) side to take out the IC chips 100 held by the first hand units 92 from the individual test sockets 61.

In parallel to such work (the test of the IC chips 100), the second hand units 93 supported by the second hand-unit supporting section 914 hold the IC chips 100 stored in the tray 52 and take out the IC chips 100 from the tray 52.

### Step 7

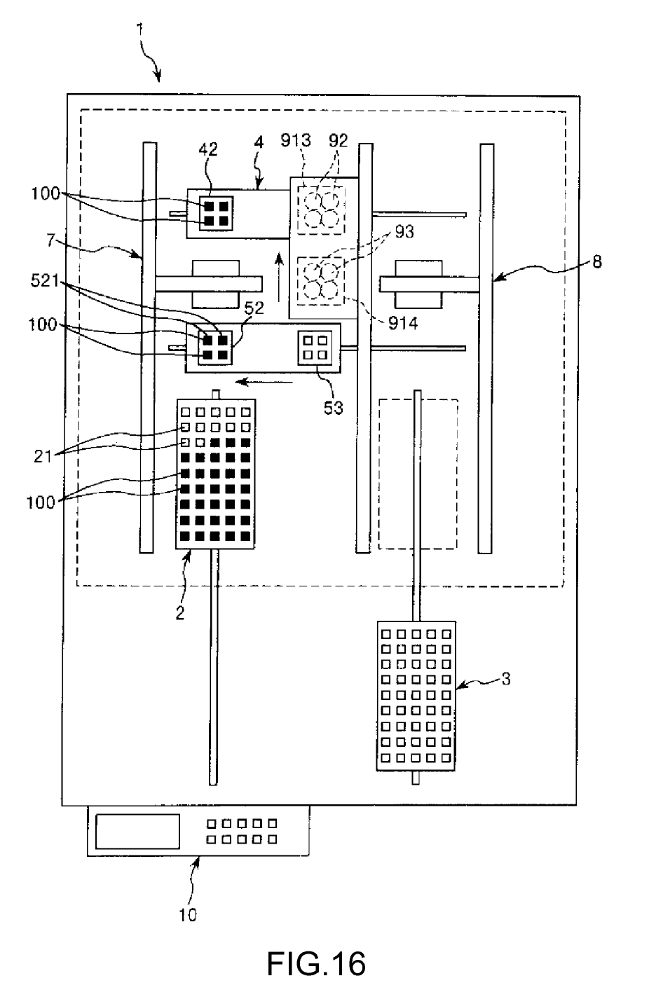

Subsequently, as shown in FIG. 16, the first and second hand-unit supporting sections 913 and 914 are integrally moved to the Y direction (+) side to locate the first hand-unit supporting section 913 right above the tray 43 of the first shuttle 4 and locate the second hand-unit supporting section 914 right above the test socket 6 (the starting point position for test). During the movement, when the second hand-unit supporting section 914 (the second hand units 93) passes right above the second camera 500, the second camera 500 picks up an image to capture the IC chips 100 held by the second hand units 93 and the device marks of the second hand units 93. The control device 10 performs, on the basis of image data obtained by the image pickup, positioning of the IC chips 100 independently for the IC chips 100 according to the method explained above.

In parallel to the movement of the first and second hand-unit supporting sections 913 and 914, work explained below is performed. First, the second shuttle 5 is moved to the X direction (−) side to arrange the tray 53 in the Y direction with respect to the test socket 6 and arrange the tray 52 in the Y direction with respect to the supply tray 2. Subsequently, the IC chips 100 stored in the supply tray 2 are transferred to the tray 52 by the supply robot 7. The IC chips 100 are stored in the pockets 521 of the tray 52.

### Step 8

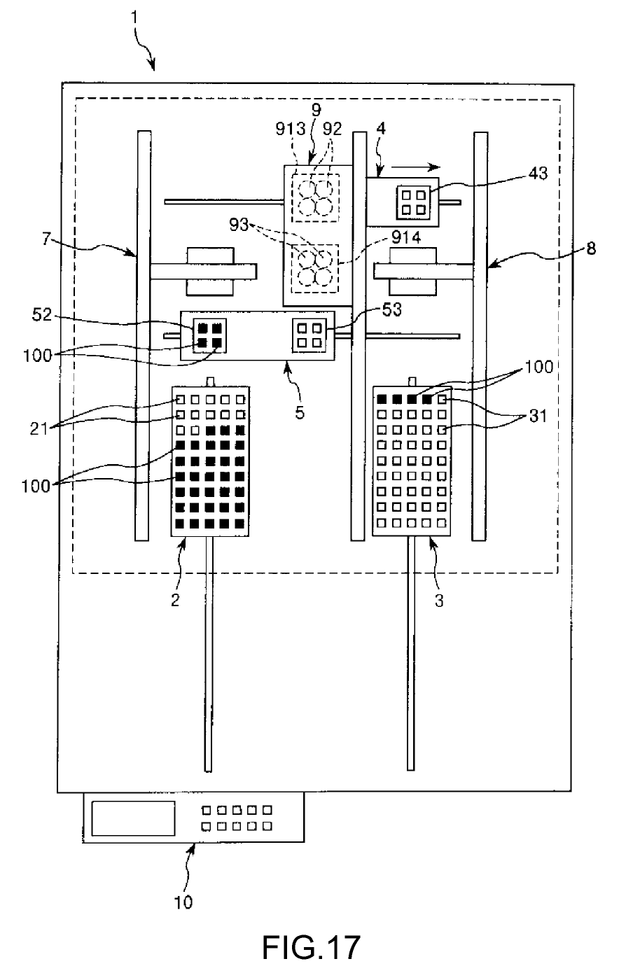

Subsequently, as shown in FIG. 17, the second hand-unit supporting section 914 is moved to the Z direction (−) side to arrange the IC chips 100 held by the second hand units 93 in the individual test sockets 61 of the test socket 6. A test of the electrical characteristics is carried out for the IC chips 100 in the individual test sockets 61 by the test control section 101. When the test ends, the second hand-unit supporting section 914 is moved to the Z direction (+) side to take out the IC chips 100 held by the second hand unit 93 from the individual test sockets 61.

In parallel to such work, work explained below is performed.

First, the tested IC chips 100 held by the first hand units 92 are stored in the pockets 431 of the tray 43. Specifically, first, the first hand units 92 are moved to the Z direction (−) side to arrange the held IC chips 100 in the pockets 431 and then release the attracted state. Subsequently, the first hand units 92 are moved to the Z direction (+) side. Consequently, the IC chips 100 held by the first hand units 92 are stored in the tray 43.

Subsequently, the first shuttle 4 is moved to the X direction (+) side to arrange the tray 42 in the Y direction with respect to the test socket 6 and locate the tray 42 right below the first hand-unit supporting section 913 (the first hand units 92) and arrange the tray 43 in the Y direction with respect to the collection tray 3. The first hand units 92 hold the IC chips 100 stored in the tray 42. In parallel to the work, the tested IC chips 100 stored in the tray 43 are transferred to the collection tray 3 by the collection robot 8.

### Step 9

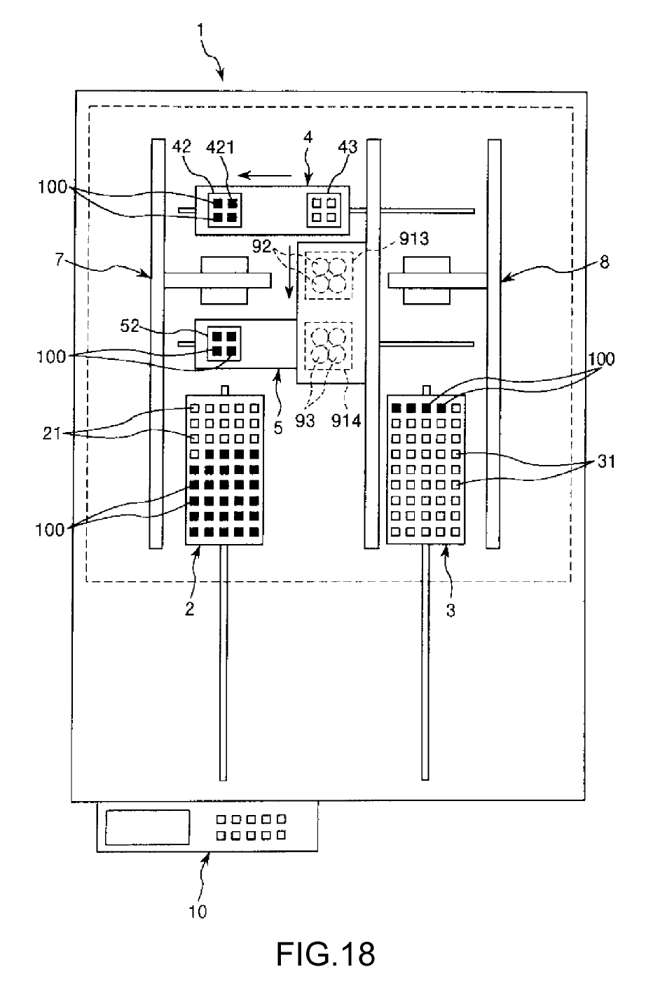

Subsequently, as shown in FIG. 18, the first and second hand-unit supporting sections 913 and 914 are integrally moved to the Y direction (−) side to locate the first hand-unit supporting section 913 right above the test socket 6 (the starting point position for test) and locate the second hand-unit supporting section 914 right above the tray 52. As in step 5, positioning of the IC chips 100 held by the first hand units 92 is performed.

In parallel to the movement of the first and second hand-unit supporting sections 913 and 914 explained above, work explained below is performed. First, the first shuttle 4 is moved to the X direction (−) side to arrange the tray 43 in the Y direction with respect to the test socket 6 and arrange the tray 42 in the Y direction with respect to the supply tray 2. Subsequently, the IC chips 100 stored in the supply tray 2 are transferred to the tray 42 by the supply robot 7. The IC chips 100 are stored in the pockets 421 of the tray 42.

### Step 10

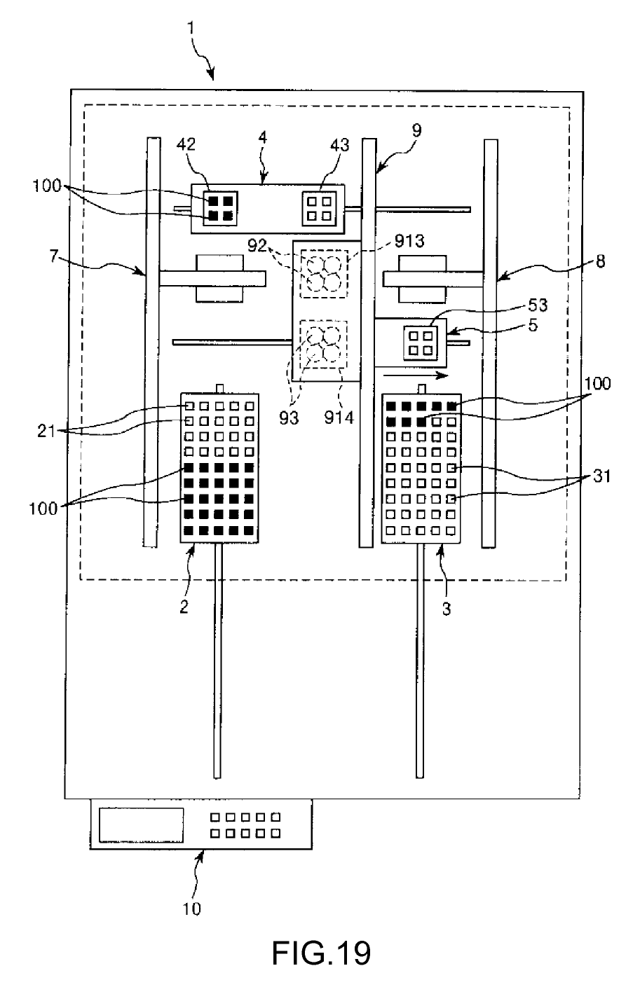

Subsequently, as shown in FIG. 19, the first hand-unit supporting section 913 is moved to the Z direction (−) side to arrange the IC chips 100 held by the first hand units 92 in the individual test sockets 61 of the test socket 6. A test of the electrical characteristics is carried out for the IC chips 100 in the individual test sockets 61 by the test control section 101. When the test ends, the first hand-unit supporting section 913 is moved to the Z direction (+) side to take out the IC chips 100 held by the first hand units 92 from the individual test sockets 61.

In parallel to such work, work explained below is performed. First, the tested IC chips 100 held by the second hand units 93 are stored in the pockets 531 of the tray 53. Subsequently, the second shuttle 5 is moved to the X direction (+) side to arrange the tray 52 in the Y direction with respect to the test socket 6 and locate the tray 52 right below the second hand-unit supporting section 914 and arrange the tray 53 in the Y direction with respect to the collection tray 3. Subsequently, the second hand units 93 hold the IC chips 100 stored in the tray 52. In parallel to this work, the tested IC chips 100 stored in the tray 53 are transferred to the collection tray 3 by the collection robot 8.

### Step 11

Thereafter, steps 7 to 10 explained above are repeated. While the steps are repeated, when all the IC chips 100 stored in the supply tray 2 are finished being transferred to the first shuttle 4, the supply tray 2 moves to the outside of the region S. After new IC chips 100 are supplied to the supply tray 2 or the supply tray 2 is replaced with another supply tray 2 on which the IC chips 100 are already stored, the supply tray 2 moves to the inside of the region S again. Similarly, while the steps are repeated, when the IC chips 100 are stored in all the pockets 31 of the collection tray 3, the collection tray 3 moves to the outside of the region S. The IC chips 100 stored in the collection tray 3 are removed or, after the collection tray 3 is replaced with another empty collection tray 3, the collection tray 3 moves to the inside of the region S again.

With the method explained above, it is possible to efficiently perform a test of the IC chips 100. Specifically, the test robot 9 includes the first hand unit 92 and the second hand unit 93. For example, in a state in which the IC chip 100 held by the first hand unit 92 (the same applies to the secondhand unit 93) is tested by the test socket 6, in parallel to the test, the second hand unit 93 stores the tested IC chip 100 on the tray 53 and stays on standby while holding the IC chip 100 to be tested next. Different kinds of work are respectively performed using the two hand units in this way. Consequently, it is possible to reduce waste of time and efficiently perform a test of the IC chips 100.

### Second Embodiment

A test apparatus according to a second embodiment of the invention is explained.

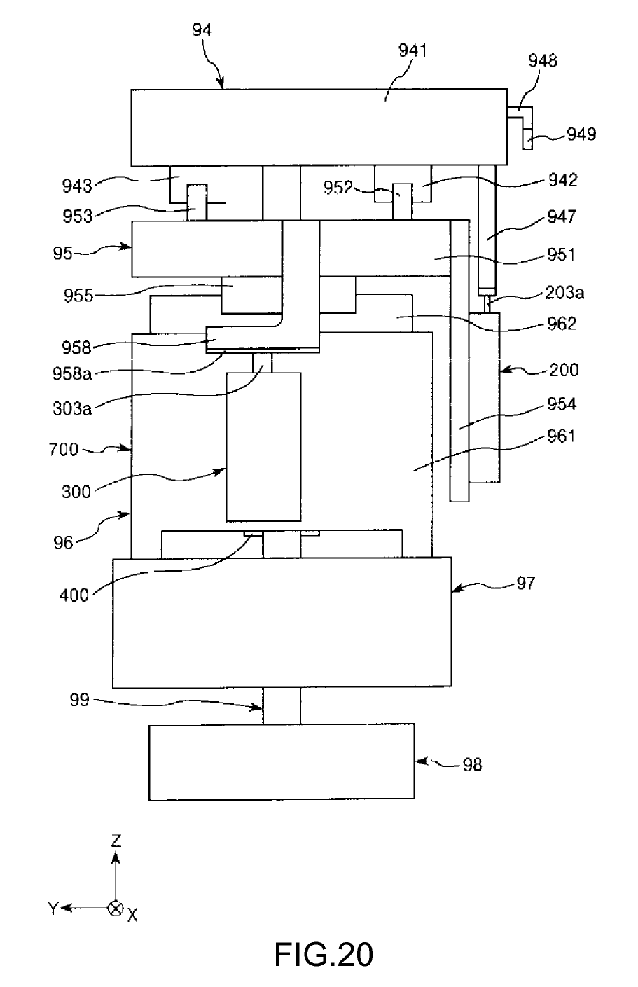

FIG. 20 is a side view of a hand unit included in the test apparatus according to the second embodiment of the invention.

Concerning the test apparatus according to the second embodiment, differences from the test apparatus according to the first embodiment are mainly explained below. The test apparatus according to the second embodiment of the invention is the same as the test apparatus according to the first embodiment except the arrangement of the second piezoelectric actuator. The components that are the same as the components in the first embodiment are denoted by the same reference numerals and signs.

As shown in FIG. 20, the second piezoelectric actuator 300 is fixed to the base section 961 of the second moving section 96. The first moving section 95 includes a contact section 958 that extends from the base section 951 toward the Z direction (−) side and comes into contact with the projection 303a of the second piezoelectric actuator 300. The contact section 958 extends to the second moving section 96. The contact section 958 is provided in the X direction with respect to the second moving section 96. A lower surface (a contact surface) 958a of the contact section 958 extends in the Y direction. The projection 303a of the second piezoelectric actuator 300 is in contact with the lower surface 958a.

The second moving section 96 is configured as a second moving section of a so-called “self-propelled type” moved in the Y direction with respect to the first moving section 95 by the driving of the second piezoelectric actuator 300 fixed to the second moving section 96. Therefore, it is possible to transmit a driving force of the second piezoelectric actuator 300 to the second moving section 96 and more smoothly and accurately move the second moving section 96 with respect to the first moving section 95. Compared with the configuration of a so-called “fixed type” as in the first embodiment, a degree of freedom of the arrangement of the second piezoelectric actuator 300 increases. It is possible to realize a reduction in the size of the first hand unit 92.

In particular, in this embodiment, both of the first moving sections 95 and the second moving section 96 are configured as moving sections of the “self-propelled type”. Therefore, a degree of freedom of the arrangement of the first and second piezoelectric actuators 200 and 300 further increases. It is possible to realize a reduction in the size of the first hand unit 92.

In the second embodiment explained above, as in the first embodiment, it is possible to show effects that are the same as the effects of the first embodiment.

The handler and the test apparatus according to the invention are explained above on the basis of the embodiments shown in the figures. However, the invention is not limited to the embodiments. The components of the sections can be replaced with arbitrary components having the same functions. Other arbitrary constituent elements may be added to the invention. The embodiments may be combined as appropriate. In the configuration explained in the embodiments, the first moving section is movable in the X direction and the second moving section is movable in the Y direction. However, conversely, the first moving section may be movable in the Y direction and the second moving section may be movable in the X direction.

The above described embodiments are merely exemplary and do not limit the scope of the invention as set forth in the claims.

The entire disclosure of Japanese Patent Application No. 2012-007468 filed Jan. 17, 2012 is hereby expressly incorporated by reference herein.

What is claimed is:

1. A handler comprising:
a holding section configured to hold an electronic component;
a base section spaced apart from the holding section and configured to move the holding section; and
a position changing section, at least a part of which is provided between the base section and the holding section, the position changing section being adapted to change a position of the electronic component held by the holding section with respect to the base section, wherein
the position changing section includes:
a two-dimensional moving section that is movable in a first direction and a second direction crossing the first direction with respect to the base section,
a pivoting section that is pivotable with respect to the two-dimensional moving section, and
a piezoelectric actuator configured to move the two-dimensional moving section with respect to the base section, and
the piezoelectric actuator moves the two-dimensional moving section.

2. The handler according to claim 1, wherein
the two-dimensional moving section includes a first moving section that is movable in a first direction and a second moving section that is movable in the second direction, and
the position changing section includes:
a first piezoelectric actuator configured to move the first moving section,
a second piezoelectric actuator configured to move the second moving section, and
a pivoting section piezoelectric actuator configured to cause the pivoting section to pivot.

3. The handler according to claim 2, wherein
the two-dimensional moving section has a columnar shape that connects the base section and the holding section,
the first piezoelectric actuator, the second piezoelectric actuator, and the pivoting section piezoelectric actuator have a tabular shape, and
tabular surfaces of the first piezoelectric actuator, the second piezoelectric actuator, and the pivoting section piezoelectric actuator are provided along a side surface of the columnar shaped two-dimensional moving section.

4. The handler according to claim 2, wherein the first piezoelectric actuator is fixed to the first moving section.

5. The handler according to claim 2, wherein the second piezoelectric actuator is fixed to the second moving section.

6. The handler according to claim 2, wherein the first piezoelectric actuator is fixed to the first moving section and the second piezoelectric actuator is fixed to the second moving section.

7. The handler according to claim 2, wherein the pivoting section piezoelectric actuator is spaced apart from a pivot axis of the pivoting section.

8. The handler according to claim 2, wherein the pivoting section includes a through-hole that pierces through the pivoting section in a pivot axis direction.

9. The handler according to claim 8, wherein the handler includes an axis direction moving section inserted through the through-hole of the pivoting section and movable in the pivot axis direction with respect to the pivoting section.

10. The handler according to claim 9, wherein a regulator that regulates a pivoting range of the axis direction moving section.

11. A test apparatus comprising:
a holding section configured to hold an electronic component;
a base section spaced apart from the holding section and configured to move the holding section;
a position changing section, at least a part of which is provided between the base section and the holding section, the position changing section being adapted to change a position of the electronic component held by the holding section with respect to the base section;
a testing section configured to test the electronic component; and
a conveying mechanism configured to convey the electronic component to the testing section, wherein
the position changing section includes:
a two-dimensional moving section movable in a first direction and a second direction crossing the first direction with respect to the base section,
a pivoting section that is pivotable with respect to the two-dimensional moving section, and
a piezoelectric actuator configured to move the two-dimensional moving section with respect to the base section, and
the piezoelectric actuator moves the two-dimensional moving section.
